(19) United States
(12) Patent Application Publication
(10) Pub. No.: US 2025/0250389 A1
(43) Pub. Date: Aug. 7, 2025

(54) THERMOPLASTIC AND ELASTOMERIC POLYURETHANES PRODUCED FROM BIOBASED 1, 5-PENTAMETHYLENE DIISOCYANATE

(71) Applicant: MOJIA (SHANGHAI) BIOTECHNOLOGY CO., LTD., Shanghai (CN)

(72) Inventors: Man Kit Lau, Shanghai (CN); Ansen Chiew, Shanghai (CN); Ibrahim Sendijarevic, Madison Heights, MI (US)

(73) Assignee: MOJIA (SHANGHAI) BIOTECHNOLOGY CO., LTD., Shanghai (CN)

(21) Appl. No.: 18/854,887

(22) PCT Filed: Apr. 7, 2022
(86) PCT No.: PCT/CN2022/085521

§ 371 Date: Oct. 7, 2024

(51) Int. Cl. C08G 18/73; C08G 18/12; C08G 18/38; C08G 18/42; C08G 18/48

(52) U.S. Cl. CPC C08G 18/73; C08G 18/12; C08G 18/3868; C08G 18/4238; C08G 18/4854

(57) ABSTRACT

Thermoplastic and elastomeric polyurethanes (PUs) are obtained from a biobased monomeric pentamethylene diisocyanate (PDI) having a biobased content of at least 70% and at least one polyol selected from a polyester diol, a polyether diol, and a combination thereof. Thermoplastic PUs are prepared by reacting the PDI and the polyol in the presence of a chain extender. Elastomer PUs are prepared by reacting the PDI and the polyol in the presence of a curative agent. In some embodiments, the thermoplastic and elastomer PUs can comprise a molar ratio of PDI to polyol of at least 1.1:1. In some embodiments, the polyol can be a biobased polyol and can have a molecular weight of at least 500 g/mol. In some embodiments, thermoplastic and elastomer PUs with biobased content of more than 90% can be prepared.

### FIELD

The present description relates to the thermoplastic and elastomeric polyurethanes produced from biobased 1,5-pentamethylene diisocyanate. More particularly, described herein are thermoplastic polyurethanes and polyurethane elastomers obtained from 1,5-pentamethylene diisocyanate and polyols selected from polyester diols and/or polyether diols. In some embodiments, the polyols can be biobased polyols.

### BACKGROUND

Thermoplastic polyurethanes (TPUs) are melt-processable polyurethanes with wide range of physico-mechanical, thermal and environmental properties, which are desirable materials in many applications, including for instance: automotive, wires and cables, breathable films for leisure, sports and textile coatings, various tubes, hot melt adhesive, etc. Due to their excellent physico-mechanical characteristics, TPUs can be considered performance materials.

Due to environmental concerns and sustainability goals, there is a demand for biobased TPUs in many applications, especially health care, textile industry, sports and leisure, footwear, automotive industry, etc. While sustainability and environmental goals are important, sustainable TPUs still need to present excellent physico-mechanical performance.

TPUs are prepared by reacting three basic building blocks, which includes isocyanate, chain extender, and polyol to form a linear segmented block copolymer composed of hard and soft segments. Hard segment is built by reaction of chain extender and diisocyanate while soft segment comprises the polyol. Physico-mechanical properties of TPUs can be controlled mainly by hard segment and flexibility and elastomeric properties by soft segment.

Commercially available biobased polyester and polyether polyols can be used in the preparation of TPUs. However, there are limited sources of biobased isocyanates available for the syntheses of TPUs. TPUs are typically prepared with aromatic diisocyanates (e.g., 4,4′-MDI) or aliphatic diisocyanates such as hydrogenated MDI (HMDI or H12MDI), hexane diisocyanate (HDI) or isophorone diisocyanate (IPDI). Development of TPUs with high bio-content would require using both biobased polyester and polyether polyols and biobased diisocyanates.

Polyurethane elastomers are produced from at least three building blocks that includes an isocyanate, a polyol, and a curative agent. The final polymer structure can be linear or cross-linked. Polyurethane elastomers can comprise urethane cast elastomers, urethane/urea cast elastomers, and spray elastomers. Typical polyurethane elastomers can be produced from two component systems, where the isocyanate and the polyol are first reacted to form an NCO-prepolymer which is subsequently reacted with the curative agent. Polyurethane elastomers are conventionally prepared from aromatic isocyanates such as toluene diisocyanate (TDI), methylene diphenyl diisocyanate (MDI), carbodiimide diiscoayantes, or aliphatic isocyanates such as IPDI and HMDI. Polyurethane elastomers can be prepared using both polyether and polyester polyols of different molecular weights, depending on the application.

Cast elastomers based on aliphatic isocyanates do not yellow with time and are used as synthetic glass and transparent coatings. Cast polyurethane/urea elastomers are also used as liners in steel pipes for transportation of abrasive slurries over vast distances and can experience a broad range of temperatures. Due to environmental concerns, development of biobased polyurethane elastomers with good physico-chemical properties would be desirable.

### SUMMARY

In a first aspect, described herein is a biobased thermoplastic polyurethane (TPU) obtained from a biobased monomeric pentamethylene diisocyanate (PDI), at least one polyol being optionally biobased selected from a polyester diol, a polyether diol, and a combination thereof, in the presence of at least one hydroxyl functionalized chain extender, wherein the PDI has a biobased content of at least 70%.

In some embodiments, the TPU can be obtained by reacting an NCO-terminated prepolymer produced from the biobased monomeric PDI and the at least one polyol, with the at least one chain extender.

In another aspect, described herein is a PDI-based elastomer obtained from a biobased monomeric pentamethylene diisocyanate (PDI) and at least one polyol selected from a polyester polyol, a polyether polyol, and a combination thereof, in the presence of at least one curative agent, wherein the PDI has a biobased content of at least 70%.

In some embodiments, the PDI-based elastomer can be obtained by reacting an NCO-terminated prepolymer produced from the biobased monomeric PDI and the at least one polyol, with the at least one curative agent.

In some embodiments, the biobased monomeric PDI can be obtained by a process comprising: subjecting a solution comprising a cadaverine salt dissolved in an inert solvent in the presence of a tertiary amine base, to a liquid-phase phosgenation reaction using a phosgene source, to convert the cadaverine to PDI, wherein the phosgenation reaction comprises a step of maintaining the reaction at a temperature range between 100° C. and 120° C. for a sufficient time to achieve a desired threshold yield of PDI, wherein the tertiary amine base is present in an amount to enable the phosgenation reaction to occur to completion at said temperature range.

In some embodiments, the polyols used to prepare the TPU or PDI-based elastomer are biobased polyols and the resulting TPU or elastomer can have high level of biobased content such as a biobased content of at least 90%.

### DETAILED DESCRIPTION

### Definitions

Headings, and other identifiers, e.g., (a), (b), (i), (ii), etc., are presented merely for ease of reading the specification and claims. The use of headings or other identifiers in the specification or claims does not necessarily require the steps or elements be performed in alphabetical or numerical order or the order in which they are presented.

The use of the word “a” or “an” when used in conjunction with the term “comprising” in the claims and/or the specification may mean “one” but it is also consistent with the meaning of “one or more”, “at least one”, and “one or more than one”.

The term “about” is used to indicate that a value includes the standard deviation of error for the device or method being employed in order to determine the value. In general, the terminology “about” is meant to designate a possible variation of up to 10%. Therefore, a variation of 1, 2, 3, 4, 5, 6, 7, 8, 9 and 10% of a value is included in the term “about”. Unless indicated otherwise, use of the term “about” before a range applies to both ends of the range.

As used herein, the terms “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or process/method steps.

The term “biobased” used in association with any compound, reactant, composition, reaction product, prepolymer, and/or polyurethane described herein means that such compound, reactant, composition, reaction product, prepolymer, and/or polyurethane contains organic carbon of renewable origin like agricultural, plant, animal, fungi, microorganisms, marine, or forestry materials living in a natural environment in equilibrium with the atmosphere.

The expressions “biobased content”, “renewable content”, “bio-content”, “biobased carbon content” are used interchangeably to designate the amount of biobased carbon in any material described herein (i.e., any compound, reactant, composition, reaction product, prepolymer, and/or polyurethane) as a percent of the total carbon in the material. In some embodiments, the biobased content of a product (e.g., prepolymer, and/or polyurethane) can be calculated from the biobased content of the reactants if known. In some embodiments, the biobased content can be determined according to ASTM D6866-18.

A “polyester polyol” as used herein comprises an aliphatic polyester comprising at least two hydroxyl groups, i.e., a compound comprising at least two hydroxyl groups and comprising repeating aliphatic moieties including at least one ester function. In some embodiments, the polyester polyol can include from 2 to 6 hydroxyl groups, more preferably from 2 to 4 hydroxyl groups.

A “polyether polyol” as used herein comprises an aliphatic polyether comprising at least two hydroxyl groups, i.e., a compound comprising at least two hydroxyl groups and comprising repeating aliphatic moieties including at least one ether function. In some embodiments, the polyether polyol can include from 2 to 6 hydroxyl groups, more preferably from 2 to 4 hydroxyl groups.

A “polyester diol” as used herein comprises a dihydroxy aliphatic polyester, i.e., a compound comprising two terminal hydroxyl groups and comprising repeating aliphatic moieties including at least one ester function. In some embodiments, polyester diols can result from the reaction of a diol with a dicarboxylic acid. In some embodiments, the polyester diol can have the formula

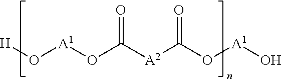

where A¹ represents a first aliphatic moiety and A² represents a second aliphatic moiety. In some embodiments, the polyester diol can result from the reaction of a diol HO-A¹-OH with a dicarboxylic acid of formula HOOC-A²-COOH.

A “polyether diol” as used herein comprises a dihydroxy aliphatic polyether, i.e., a compound comprising two terminal hydroxyl groups and comprising repeating aliphatic moieties including at least one ether function. In some embodiments, the polyether diol can have the formula

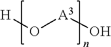

where A³ represents an aliphatic moiety.

The term “aliphatic” or “aliphatic moiety”, as used herein, denotes a hydrocarbon moiety that can be straight chain (i.e., unbranched or linear), branched, or cyclic and can be completely saturated or can contain one or more units of unsaturation, but which is not aromatic. In some embodiments, the aliphatic moiety can include a linear or branched alkylenyl group, i.e., a divalent analogue of a linear or branched alkyl group. Unless otherwise specified, each aliphatic group/moiety can contain from 1 to 20 carbon atoms, e.g., 1, 2, 3, 4, 5, 6, 7, 8, 9, 10, 11, 12, 13, 14, 15, 16, 17, 18, 19 or 20 carbon atoms.

The terms “chain extender” and “curative agent” represent a hydroxyl functionalized or amino functionalized compound that can react with diisocyanato groups to build the polyurethane molecular weight. In some embodiments, the chain extender can be a diol. In some embodiments, the curative agent can act as a chain extender or crosslinker to form a linear or cross-linked polyurethane. In some embodiments, the curative agent can be a sterically hindered amine, a diol, a polyol, a secondary diamine, a diamine ether oligomer, and any combination thereof.

As used herein, a “sterically hindered amine” represents a compound in which the nitrogen atom of the amine molecule is partially shielded by neighboring groups so that larger molecules cannot easily approach and react with the nitrogen. In some embodiments, the sterically hindered amine can be a primary amine in which the amino group is attached to a tertiary carbon or a carbon from an aromatic ring, or can be a secondary amine in which the amino group is attached to at least one secondary or tertiary carbon or a carbon from an aromatic ring.

The present disclosure relates to polyurethanes which can be prepared from biobased pentamethylene diisocyanate (PDI). PDI is a diisocyanate of formula O═C═N—(CH₂)₅—N═C═O and thus contains five methylene groups and two terminal isocyanato groups. In some embodiments, the polyurethanes can be prepared from PDI and polyols such as polyester diols or polyether diols, as will be detailed below. Depending on the selection of the polyol which can be reacted with PDI, polyurethanes of various properties can be prepared. As will be described in more detail below, the preparation of the polyurethanes can involve reacting an NCO-terminated prepolymer prepared from PDI and at least one polyol, with either a chain extender or a curative agent, to provide polyurethanes presenting either thermoplastic or elastomeric (e.g., thermosetting) characteristics. The polyurethanes of the present disclosure can thus present interesting physico-chemical properties and can be used in many different applications.

In some aspects, described herein is a biobased thermoplastic polyurethane (TPU) prepared from a biobased monomeric pentamethylene diisocyanate (PDI) having a biobased content of at least 70% and at least one polyol being optionally biobased selected from a polyester diol, a polyether diol, and a combination thereof, in the presence of at least one hydroxyl functionalized chain extender.

In other aspects, described herein is a PDI-based elastomer prepared from a biobased monomeric pentamethylene diisocyanate (PDI) having a biobased content of at least 70% and at least one polyol selected from a polyester polyol, a polyether polyol, and a combination thereof, in the presence of at least one curative agent.

In some embodiments, the thermoplastic polyurethane and/or polyurethane elastomer can be prepared using PDI in combination with other isocyanate(s). When a combination of isocyanates is used, PDI is preferably used as the main isocyanate. In preferred embodiments, PDI is used as sole isocyanate.

### Biobased Pentamethylene Diisocyanate (PDI)

In some embodiments, the PDI that is used for preparing the polyurethanes, e.g., TPUs and/or elastomers, described herein, can be produced by a process as described in PCT/CN2020/120154, which is incorporated herein by reference.

Hence, in some embodiments, the PDI can be produced from a cadaverine salt, by a process comprising:
(a) providing a phosgene source;
(b) providing a solution comprising a cadaverine salt dissolved in an inert solvent in the presence of a tertiary amine base; and
(c) subjecting the solution to a liquid-phase phosgenation reaction to convert the cadaverine to PDI, the phosgenation reaction comprising a step of maintaining the reaction at a temperature range between 100° C. and 120° C. for a sufficient time to achieve a desired threshold yield of PDI,
   wherein the tertiary amine base is present in an amount sufficient to enable the phosgenation reaction to occur to completion at said temperature range.

In some embodiments, the phosgenation reaction temperature in step (c) does not exceed about 119, 118, 117, 116, 115, 114, 113, 112, 111, or 110° C.; and/or does not fall below 30, 31, 32, 33, 34, 35, 36, 37, 38, 39, 40, 41, 42, 43, 44, 45, 46, 47, 48, 49, or 50° C.

In some embodiments, the phosgenation reaction in (c) can comprise a step of maintaining the reaction at temperatures between 100 and 115, 105 and 115, 110 and 115, or 100 and 110° C.; or at about 110° C. for a sufficient time to achieve a threshold yield of PDI.

In some embodiments, said sufficient time in (c) can be at least 1.5, 2, 2.5, or 3 hours; or for 1.5 to 6, 2 to 6, 2 to 5.5, 2.5 to 5.5, 2.5 to 6, or 3 to 5 hours.

In some embodiments, the phosgenation reaction in (c) can be a multistage phosgenation reaction comprising at least a first stage in which the solution is heated to a first temperature such that the cadaverine reacts with phosgene from the phosgene source to produce a dicarbamoyl chloride intermediate, and a subsequent second stage in which the solution is further heated to a second temperature higher than the first temperature to subject the dicarbamoyl chloride intermediate to dehydrochlorination, wherein the second stage comprises said step of maintaining the reaction at temperatures between 100° C. and 120° C. for a sufficient time to achieve a threshold yield of PDI.

In some embodiments, the first temperature can be from about 30 to 65, 35 to 65, 35 to 60, 40 to 60, 35 to 55, 40 to 55, or 45 to 55° C.; or is about 50° C.

In some embodiments, the first stage can comprise maintaining the solution at the first temperature for at least 0.5, 1, or 2 hours; or for 0.5 to 3, 0.5 to 2.5, 0.5 to 2, 1 to 2.5, or 1 to 2 hours.

In some embodiments, the second temperature can be higher than the first temperature by at least 10, 15, 20, 25, 30, 35, 40, 45, 50, 55, or 60° C.

In some embodiments, the amounts of the phosgene source and/or tertiary amine base reactants employed in the multistage phosgenation reaction is lower than the amounts required to achieve the same PDI yield as a corresponding single-stage phosgenation reaction occurring only at the second temperature.

In some embodiments, the process to produce PDI employs 3 to 30, 4 to 29, 4 to 27, 4 to 24, 4 to 18, 4.5 to 18 mols of phosgene per mole of cadaverine salt. In some embodiments, the process employs at least 4, 4.5, 5, 5.5, or 6 mols of tertiary amine base per mole of cadaverine salt.

In some embodiments, the cadaverine salt can be a bio-based cadaverine salt obtained from fermentation (e.g., of a microorganism engineered to produce cadaverine) and/or enzymatic conversion (e.g., from lysine), the enzymatic conversion preferably occurring via an immobilized whole (intact) cell biocatalyst to reduce impurities from cell lysis components.

In some embodiments, the cadaverine salt can be produced without distillation, or was not otherwise subjected to temperatures conducive to the formation of cyclic by-product impurities. In some embodiments, the cyclic by-products and/or other impurities described herein may comprise THP, piperidine, piperidine; 2-(aminomethyl)-3,4,5,6-tetrahydropyridine; 1-piperidinecarbonyl chloride; 1 (2H)-pyridinecarbonylchloride, or polymeric (insoluble) impurities that impart a darker color to the PDI produced. As used herein, the term “impurity” refers to any compound or material present in a raw material (e.g., cadaverine salt) and/or end product (e.g., PDI) that would negatively interfere with the performance of the end product for its intended commercial purpose. For example, any undesirable compound or material may interfere with the performance of PDI in polymerization reactions (e.g., in polyurethane production) is considered an impurity. In some embodiments, the content of THP or other cyclic by-product impurity in the cadaverine salt described herein may be below 0.1, 0.09, 0.08, 0.07, 0.06, 0.05, 0.04, 0.03, 0.02, or 0.01 wt %.

In some embodiments, the cadaverine salt is cadaverine dihydrochloride.

In some embodiments, the phosgene source is phosgene gas or triphosgene. In some embodiments, the phosgene source is triphosgene and the tertiary amine base is reacted with the triphosgene to release phosgene for the phosgenation reaction.

In some embodiments, the phosgene source is triphosgene and the tertiary amine base serves to facilitate dissolution of the cadaverine salt, to react with the triphosgene to release phosgene, and to catalyze the subsequent phosgenation reaction at the phosgenation temperature range.

In some embodiments, the tertiary amine base is a heterocyclic amine or a tertiary amine base having an sp²-hybridized N atom. In some embodiments, the tertiary amine base can be pyridine.

In some embodiments, the inert solvent comprises or consists of chlorobenzene, dichlorobenzene, toluene, nitrobenzene, or any mixture thereof. In some embodiments, the inert solvent is a solvent or solvent mixture having a boiling point of at least 120, 125, or 130° C.

In some embodiments, the process to prepare the PDI can be performed as a one-pot synthesis in which the cadaverine salt and phosgene source are slowly combined in the inert solvent in the presence of the tertiary amine base in a single vessel and subsequently heated to begin the phosgenation reaction.

In some embodiments, the PDI produced by the process as described herein may be subjected to a distillation purification step.

In some embodiments, the PDI produced has a content of THP or other cyclic by-product impurity of below 0.1, 0.09, 0.08, 0.07, 0.06, 0.05, 0.04, 0.03, 0.02, or 0.01 wt % before being subject to one or more distillation steps.

In some embodiments, the PDI produced has a degree of purity of at least 99 wt %, or of 99.1 wt %, 99.2 wt %, 99.3 wt %, 99.4 wt %, 99.5 wt %, 99.6 wt %, 99.7 wt %, 99.8 wt %, or 99.9 wt %.

In some embodiments, the desired threshold yield of PDI is at least 50, 55, 60, 65, 70, 75, or 80%.

In some embodiments, the PDI produced has a biobased content of at least 70%, e.g., at least 71%.

The biobased PDI that is produced and used in the present disclosure to prepare the NCO-terminated prepolymer and then the polyurethanes, is in monomeric form, and differs from other known commercially available PDI which is usually in trimeric form.

### Polyester and Polyether Polyols

As mentioned above, the polyurethanes of the present disclosures, i.e., TPUs and/or elastomers, are prepared by reacting the PDI described herein with at least one polyol selected from polyester polyols and/or polyether polyols in the presence of either a chain extender or a curative agent.

In some embodiments, TPUs can be prepared from polyols including polyester diol and/or polyether diol, which can be biobased or non-sustainable or a mixture of a both biobased and non-sustainable polyols.

In some embodiments, elastomers can be prepared from polyester polyols and/or polyether polyols with a hydroxyl functionality of from 2 to 6, preferably from 2 to 4, and more preferably 2. These polyester polyols and/or polyether polyols can be biobased or non-sustainable or a mixture of a both biobased and non-sustainable polyols.

In some embodiments, the polyol can be a polyester diol, a polyether diol or any combination thereof. In some embodiments, the polyol, i.e., the polyester diol and/or polyether diol can be biobased. In some embodiments, the polyol can be a biobased polyester diol and/or polyether diol, having a biobased content of at least 90%, or at least 95% or at least 99%, or at least 99.1%, 99.2%, 99.3%, 99.4%, 99.5%, 99.6%, 99.7%, 99.8 5, or 99.9%, or about 100%. Alternatively, the polyol can be non-sustainable, or a mixture of a both biobased and non-sustainable polyols can be used. When using a biobased polyol, one can reach very high content of biobased content in the final polyurethane, which can be advantageous on a sustainable standpoint.

In some embodiments, the polyester diol can be selected from a succinate based polyester diol, an adipate based polyester diol, a sebacate based polyester diol, an azelate based polyester diol, a 1,18-octadecanedioic diacid based polyester diol, or any combination thereof. In other embodiments, the polyester diol can be synthesized from an organic diacid selected from succinic acid, adipic acid, sebacic acid, azelaic acid, a 1,18-octadecanedioic diacid, and any combination thereof, with a diol being selected from 1,4-Butanediol (1,4-BDO), 1,3-Propanediol (1,3-PDO), and a mixture thereof. In particular embodiments, the polyester diol can be selected from 1,4-BDO-adipate, 1,3-PDO-adipate, 1,4-BDO-Sebacate, 1,3-PDO-sebacate, and any combination thereof. For certain applications, the polyester diol can be 1,3-PDO-sebacate. In some embodiments, blends of polyester diols can be used to adjust the polyurethane properties.

In some embodiments, the polyether diol can be selected from a polytrimethylene ether glycol (PO3G), a polytetramethylene ether glycol (PTMEG or PTMG), a polyethylene glycol, and any combination thereof. In some particular embodiments, the polyether diol can be a polytrimethylene ether glycol (PO3G). In other particular embodiments, the polyether diol can comprise at least one polytetramethylene ether glycol (PTMEG or PTMG). In some embodiments, blends of polyether diols can be used to adjust the polyurethane properties. For instance, one can use mixtures of PTMEGs of different molecular weights.

In some embodiments, the polyol, i.e., the polyether polyol and/or the polyester polyol can have a molecular weight ranging from at least 500 g/mol, for instance from 500 g/mol to about 10000 g/mol. Hence, the polyether diol can have a molecular weight ranging from 500 to about 10000 g/mol, from 500 to about 9000 g/mol, 500 to about 8000 g/mol, 500 to about 7000 g/mol, 500 to about 6000 g/mol, 500 to about 5000 g/mol, 500 to about 4000 g/mol, 500 to about 3000 g/mol, 500 to about 2000 g/mol, 500 to about 1000 g/mol. In some embodiments, the polyether polyol, preferably a polyether polyol diol, can have a molecular weight ranging from 500 to about 3000 g/mol.

In some embodiments, the polyol can be demoisturized before being used, to reach a water content below 0.1 wt %, preferably below 0.06 wt % based on the weight of the polyol.

### PDI-Based Thermoplastic Polyurethanes

As mentioned previously, the present disclosure aims to provide polyurethanes based on biobased PDI. In some embodiments, PDI-based thermoplastic polyurethanes (TPUs) can be prepared from at least one polyol and the biobased monomeric PDI, as described above, in the presence of at least one chain extender. TPUs can be obtained by first reacting at least one polyol with PDI to form an NCO-terminated prepolymer which is subsequently reacted with at least one chain extender. Alternatively, TPUs can be obtained by reacting PDI with at least one polyol and at least one chain extender in a single step synthesis.

In some embodiments, the TPUs can be prepared such that molar ratios of PDI to polyol to chain extender can range from 1.5:1:0.5 to 4:1:3. In other embodiments, the molar ratio of PDI to polyol to chain extender used to prepare the TPUs can be from about 1.5:1:0.5 to about 3:1:2. In further embodiments, the molar ratio of PDI to polyol to chain extender can be from about 2:1:1 to about 3:1:1. The ratios of each component can be determined and calculated to adjust the physico-chemical properties of the TPUs.

As mentioned above, in some embodiments, the TPUs can be obtained by first preparing an NCO-terminated prepolymer in the presence of a chain extender. In some embodiments, the NCO-terminated prepolymer can include excess isocyanate that is left in the product, and it can be referred to as a “quasi-prepolymer”. Hence, the expression “NCO-terminated prepolymer” as used in the present description includes a prepolymer and/or a quasi-prepolymer.

In some embodiments, the NCO-terminated prepolymer can be produced using a demoisturized polyol. For instance, the polyol can be demoisturized before preparing the NCO-terminated prepolymer to reach a water content below 0.1 wt %, preferably below 0.06 wt % based on the weight of the polyol.

The NCO-terminated prepolymer can be prepared by mixing the PDI and the polyol at the desired ratios and heating the mixture. In some embodiments, the reaction advancement can be monitored via NCO % titration. In some embodiments, the NCO-terminated prepolymer can be produced by reacting the PDI and the polyol at 1.1:1 to 10:1 molar ratio. In some embodiments, the NCO-terminated prepolymer can be produced by reacting the PDI and the polyol at a molar ratio of at least 2:1. In some embodiments, the molar ratio of PDI to polyol can be from 1.5:1 to 4:1, or from 1.5:1 to 3.5:1, or from 1.5:1 to 3:1, or from 2:1 to 3:1. In some embodiments, the NCO-terminated prepolymer can be produced by reacting the PDI and the polyol under heating at a temperature ranging from about 50° C. to about 120° C. In some embodiments, the NCO-terminated prepolymer can be produced by mixing the PDI and the polyol in the absence of any catalyst.

As mentioned above, the PDI is biobased and can have a biobased content of at least 70%. When using a biobased polyol, i.e., a biobased polyether diol and/or biobased polyester diol for preparing the NCO-terminated prepolymer, one can reach very high content of biobased content in the NCO-terminated prepolymer, which can be advantageous on a sustainable standpoint. In some embodiments, the NCO-terminated prepolymer can reach a biobased content of at least 90%. In some embodiments, the NCO-terminated prepolymer can have a biobased content of from about 90% to about 95%, or from about 90% to about 96%, or from about 90% to about 97%, or from about 90% to about 98%, or from about 90% to about 99%, or from about 90% to about 100%. In some embodiments, the biobased content of the NCO-terminated prepolymer can be about 90%, or about 91%, or about 92%, or about 93%, or about 94%, or about 95%, or about 96%, or about 97%, or about 98%, or about 99%, or about 99.5%, or about 99.6%, or about 99.7%, or about 99.8%, or about 99.9%, or about 100%.

In some embodiments, the NCO-terminated prepolymer can also be characterized by a viscosity at 70° C. ranging from about 100 cps to about 10000 cps, or from about 100 cps to about 9000 cps, or from about 100 cps to about 8000 cps, or from about 100 cps to about 7000 cps, or from about 200 cps to about 10000 cps, or from about 200 cps to about 9000 cps, or from about 200 cps to about 8000 cps, or from about 200 cps to about 7000 cps, or from about 300 cps to about 10000 cps, or from about 300 cps to about 9000 cps, or from about 300 cps to about 8000 cps, or from about 300 cps to about 7000 cps, or from about 400 cps to about 10000 cps, or from about 400 cps to about 9000 cps, or from about 400 cps to about 8000 cps, or from about 400 cps to about 7000 cps, or from about 500 cps to about 10000 cps, or from about 500 cps to about 9000 cps, or from about 500 cps to about 8000 cps, or from about 500 cps to about 7000 cps. In some embodiments, the viscosity of the NCO-terminated prepolymer at 70° C. can particularly be from about 500 cps to about 7000 cps.

Suitable chain extenders that can be used to prepare the TPUs are known in the field. They can be low molecular weight molecules such as low molecular weight diols, which will allow to build the polyurethane and increase the block length of the hard segment. In some embodiments, the chain extender can be selected from 1,3-PDO, butane diols, pentane diols, hexanediols, ethylene glycol, propylene glycol, Hydroquinone bis(2-hydroxyethyl) ether (HQEE), 1,3-bis(2-hydroxyethyl) resorcinol (HER), cyclohexane dimethanol (CHDM), 3-methyl-1,5-pentanediol, 2-butyl-2-ethyl-1,3-propanediol, and any combination thereof. In some embodiments, the chain extender can be a biobased chain extender. In certain embodiments, the chain extender is selected from biobased 1,3-PDO and biobased 1,4-BDO. In other embodiments, the chain extender has an odd number of carbon atoms. In particular embodiments, the chain extender is biobased 1,3-PDO.

In some embodiments, the TPUs can be prepared by reacting the NCO-terminated prepolymer with the chain extender under heating with or without catalyst. Alternatively, the TPUs can be prepared by reacting the polyol, PDI and the chain extender in a single synthesis step under heating with or without catalyst. Conventional catalysts used in polyurethane synthesis can be used. In some embodiments, the prepolymer can be heated prior to mixing with the chain extender. Furthermore, additives such as pigments, flame retardants, fillers, colorants, processing aids, plasticizers, stabilizers, antioxidants, mold release agents, to name a few examples, can also be added to the mixture. In some embodiments, the obtained TPUs can be subjected to post curing using conventional methods.

The biobased TPUs prepared according to the present disclosure, can have a biobased content of from about 90% to about 95%, or from about 90% to about 96%, or from about 90% to about 97%, or from about 90% to about 98%, or from about 90% to about 99%, or from about 90% to about 100%. In some embodiments, the biobased TPUs can have a biobased content of about 90%, or about 91%, or about 92%, or about 93%, or about 94%, or about 95%, or about 96%, or about 97%, or 98 about % or about 99%, or about 99.5%, or about 99.6%, or about 99.7%, or about 99.8%, or about 99.9% or about 100%.

In some embodiments, the TPUs of the present disclosure can have various properties and physico-chemical characteristics. For instance, the TPUs can present a content of hard segment that can range from about 10 wt % to about 40 wt %, or from about 10 wt % to about 30 wt %, or from about 10 wt % to about 20 wt %, or from about 15 wt % to about 40 wt %, or from about 15 wt % to about 30 wt %, or from about 15 wt % to about 20 wt %, or from about 20 wt % to about 40 wt %, or from about 20 wt % to about 30 wt %, or from about 25 wt % to about 40 wt %, or from about 25 wt % to about 30 wt %. In some embodiments, the TPUs can present a content of hard segment or from about 13 wt % to about 18 wt %.

In some embodiments, TPUs with a content of hard segment from about 20 wt % to about 30 wt % can be obtained from the biobased PDI described herein and biobased 1,3-PDO-sebacate polyester diol having a molecular weight of about 1000 g/mol as the polyol, using a chain extender that is biobased 1,3-PDO and a molar ratio of PDI to biobased polyol to chain extender of about 2:1:1.

In some embodiments, TPUs with a content of hard segment from about 25 wt % to about 30 wt % can be obtained from the biobased PDI described herein and biobased 1,3-PDO-sebacate polyester diol having a molecular weight of about 1000 g/mol as the polyol, using a chain extender that is biobased 1,3-PDO and a molar ratio of PDI to biobased polyol to chain extender of about 2:1:1.

In some embodiments, TPUs with a content of hard segment from about 10 wt % to about 20 wt % can be obtained from the biobased PDI described herein and biobased 1,3-PDO-sebacate polyester diol having a molecular weight of about 2000 g/mol as the polyol, using a chain extender that is biobased 1,3-PDO and a molar ratio of PDI to biobased polyol to chain extender of about 2:1:1.

In some embodiments, TPUs with a content of hard segment from about 13 wt % to about 18 wt % can be obtained from the biobased PDI described herein and biobased 1,3-PDO-sebacate polyester diol having a molecular weight of about 2000 g/mol as the polyol, using a chain extender that is biobased 1,3-PDO and a molar ratio of PDI to biobased polyol to chain extender of about 2:1:1.

In some embodiments, the TPUs can be characterized by their tensile stress-strain properties, such as tensile strength, elongation at break, modulus, tensile set, toughness.

In some embodiments, TPUs can be obtained having a tensile stress at break at room temperature of at least 2000 psi, or at least 2500 psi, or at least 3000 psi.

In some embodiments, TPUs having a tensile stress at break at room temperature of at least 3000 psi can be obtained from the biobased PDI described herein and biobased 1,3-PDO-sebacate polyester diol using a chain extender that is biobased 1,3-PDO.

The biobased TPUs of the present disclosure can be used in various applications. In some embodiments, they can be used, without being limited to, in the production of footwear, eyewear, pipes, tubes, hoses, rollers, wheels, gaskets, seals, hot melt adhesives, expandable TPUs, belts, wire coatings, metal coatings, pipe coatings, sieve coatings, laminates, tags, inflatables, textile coatings, garments, barrier films, sporting goods, or medical devices.

### PDI-Based Polyurethane Elastomers

As mentioned previously, the present disclosure also aims to provide polyurethane elastomers, which can be prepared from the biobased PDI described herein. In some embodiments, PDI-based elastomers can be prepared by reacting the biobased monomeric PDI and at least one polyol as described above, in the presence of at least one curative agent. These PDI-based polyurethane elastomers can comprise urethane cast elastomers, urethane/urea cast elastomers, and spray elastomers.

PDI-based elastomers can be obtained by first reacting at least one polyol with PDI to form an NCO-terminated prepolymer which is subsequently reacted with at least one curative agent. Alternatively, PDI-based elastomers can be obtained by reacting PDI with at least one polyol and at least one curative agent in a single step synthesis. Where the PDI-based elastomers are obtained by first preparing an NCO-terminated prepolymer, the NCO-terminated prepolymer can be prepared as described above with respect to the preparation of TPUs.

In some embodiments, the elastomers can be prepared such that molar ratios of PDI to polyol are from 1.1:1 to 10:1. In other embodiments, the molar ratios of PDI to polyol can range from 1.5:1 to 4:1. In further embodiments, the elastomers can comprise molar ratio of PDI to polyol of from 2:1 to 3:1. The ratios of each component can be determined and calculated to adjust the physico-chemical properties of the elastomers.

Examples of curative agents include sterically hindered amine (e.g., hindered diamines curative), secondary diamine curatives, short diol curatives, polyols, diamine ether oligomers such as primary diamine ether oligomers, and mixtures thereof. Suitable curative agents that can be used for preparing the polyurethane elastomer are known in the filed. In some embodiments, the curative agent can include at least one sterically hindered diamine. In some embodiments, the sterically hindered diamine can include two primary amino groups, one primary amino group and one secondary amino group, or two secondary amino groups. In some embodiments, the sterically hindered diamine used to prepare the elastomer can comprise an aromatic diamine. Examples of sterically hindered diamines include Dimethyl thio-toluene diamine (DMTDA), Diethyltoluene diamines such as 3,5-Diethyltoluene-2,4-diamine and 3,5-Diethyltoluene-2,6-diamine or a mixture thereof), or 4,4′-Methylene-bis(2-chloroaniline) (MOCA). These sterically hindered amines can be used in combinations. In some embodiments, the curative agent can include a diamine ether oligomer, i.e., a diamine attached to a polyether backbone typically based on ethylene oxide (EO), propylene oxide (PO) or a mix of such compounds. Examples of such diamine ether oligomers are the products sold under the tradename JEFFAMINE®. In some embodiments, where the preparation of the PDI-based elastomer involves the preparation of the NCO-terminated prepolymer, the curative agent can be reacted with the NCO-terminated prepolymer in a molar ratio NCO-terminated prepolymer to diamine of from about 0.95:1 to about 1.10:1, e.g., about 1.05:1.

In some embodiments, PDI-based elastomer can be prepared by reacting the polyol, PDI and the curative agent, or reacting the NCO-terminated prepolymer with the curative agent, under heating with or without catalyst. Conventional catalysts used in polyurethane synthesis can be used. In some embodiments, the prepolymer can be heated prior to mixing with the chain extender. Furthermore, additives such as pigments, flame retardants, fillers, colorants, processing aids, plasticizers, stabilizers, antioxidants, mold release agents, to name a few examples, can also be added to the mixture.

Depending on whether biobased polyols are used, the polyurethane elastomers will have biobased contents that can vary. At least the biobased content provided by the PDI will be counted in the biobased content of the polyurethane elastomers. The biobased content of the PDI-based elastomers can for instance vary from about 20% to about 100%. In some embodiments, the biobased content of the PDI-based elastomers can vary from about 30% to about 100%, from about 40% to about 100%, from about 50% to about 100%, from about 60% to about 100%, from about 70% to about 100%, from about 80% to about 100%, or from about 90% to about 100%, such as at least 20%, at least 30%, at least 40%, at least 50%, at least 60%, at least 70%, at least 80%, at least 90%, at least 91%, at least 92%, at least 93%, at least 94%, at least 95%, at least 96%, at least 97%, at least 98%, or at least 99%.

In some embodiments, the PDI-based elastomers can be characterized by various physico-chemical properties. Amongst properties of interest, one can cite hardness, resilience, tensile strength, elongation at break, abrasion resistance, to name a few.

In some embodiments, the PDI-based elastomer of the present disclosure can present both a hardness and resilience that are higher than the hardness and resilience of an Isophorone diisocyanate-based elastomer (IPDI-based elastomer) where the IPDI-based elastomer is prepared using the same polyol, same curative agent and in the same molar ratio and conditions as the PDI-based elastomer. This behavior is somewhat unexpected since PDI-based elastomers have lower hard segment concentration than those based on IPDI, which would typically result in lower hardness. In some embodiments, the resilience of the PDI-based elastomer can be at least 1.2 times higher than the resilience of the IPDI-based elastomer where the IPDI-based elastomer is prepared using the same polyol, same curative agent and in the same conditions as the PDI-based elastomer. By the “same conditions”, it is meant, substantially the same or identical molar ratios of reactants (PDI, polyol, curative agent) and substantially the same or identical reaction parameters such as temperature and reaction time, for the preparation of the elastomers, in a single step synthesis or through the preparation of the NCO-terminated polymers.

In other embodiments, the PDI-based elastomer can present both a tensile strength at break and an elongation at break at room temperature, that are higher than the tensile strength at break and the elongation at break at room temperature of an IPDI-based elastomer that is prepared using the same polyol, same curative agent and in the same molar ratio and conditions as the PDI-based elastomer. In some embodiments, the tensile strength at break at room temperature of the PDI-based elastomer can be at least 1.8 times higher than the tensile strength at break at room temperature of the IPDI-based elastomer.

In other embodiments, the PDI-based elastomer can present an abrasion resistance that is higher than the abrasion resistance of an IPDI-based elastomer prepared using the same polyol, same curative agent and in the same molar ratio and the same conditions as the PDI-based elastomer.

In some embodiments, the PDI-based elastomer can also present a tear strength that is higher than the tear strength of an IPDI-based elastomer prepared using the same polyol, same curative agent and in the same molar ratio and the same conditions as the PDI-based elastomer.

In some embodiments, the PDI-based elastomers of the present disclosure are castable and can be qualified as cast elastomers, i.e., elastomers that can be stretched and can recover their initial form on release. These elastomers can be thermosetting as are natural and synthetic rubbers. Alternatively, the elastomers obtained from the biobased PDI can be sprayable elastomers.

The PDI-based elastomers of the present disclosure can be used in various applications. In some embodiments, they can be used, without being limited to, in the production of footwear (e.g., shoe sole), liners, metal coatings, pump seals, rod wipers, snow plough blades, valves, wheels, tires, agitator blades, rollers, rolls, gaskets, seals, pulleys, bumpers, shock absorbers, bushings, bearings, wear strips, slide plates, machine parts, housings, escalator parts, couplings, fixture blocks, grommets, hammers, striker pads, wood-sorter pads, gears, or sprockets.

### Items

In some aspects, the present disclosure relates to one or more of the following items.
Item 1—A biobased thermoplastic polyurethane (TPU) obtained from a biobased monomeric pentamethylene diisocyanate (PDI), at least one polyol being optionally biobased selected from a polyester diol, a polyether diol, and a combination thereof, in the presence of at least one hydroxyl functionalized chain extender, wherein the PDI has a biobased content of at least 70%.
Item 2—The biobased TPU according to item 1, wherein PDI is used as sole isocyanate.
Item 3—The biobased TPU according to item 1 or 2, wherein the polyester diol is optionally biobased and comprises a succinate based polyester diol, an adipate based polyester diol, a sebacate based polyester diol, an azelate based polyester diol, a 1,18-octadecanedioic diacid based polyester diol, or any combination thereof.
Item 4—The biobased TPU according to any one of items 1 to 3, wherein the polyester diol is optionally biobased and is synthesized from an organic diacid selected from succinic acid, adipic acid, sebacic acid, azelaic acid, a 1,18-octadecanedioic diacid, and any combination thereof, with the diol being selected from 1,4-Butanediol (1,4-BDO), 1,3-Propanediol (1,3-PDO), and a mixture thereof.
Item 5—The biobased TPU according to any one of items 1 to 4, wherein the polyester diol is optionally biobased and is selected from 1,4-BDO-adipate, 1,3-PDO-adipate, 1,4-BDO-Sebacate, 1,3-PDO-sebacate, and any combination thereof.
Item 6—The biobased TPU according to any one of items 1 to 5, wherein the polyester diol is biobased 1,3-PDO-sebacate.
Item 7—The biobased TPU according to any one of items 1 to 6, wherein the polyether diol is optionally biobased and is selected from a polytrimethylene ether glycol (PO3G), a polytetramethylene ether glycol (PTMEG or PTMG), a polyethylene glycol, and any combination thereof.
Item 8—The biobased TPU according to any one of items 1 to 7, wherein polyether diol is biobased polytrimethylene ether glycol (PO3G).
Item 9—The biobased TPU according to any one of items 1 to 8, wherein the polyester diol and/or the polyether diol is biobased and has/have a biobased content of at least 99%.
Item 10—The biobased TPU according to any one of items 1 to 9, wherein the polyol has a molecular weight of at least 500 g/mol, for instance ranging from 500 to about 10000 g/mol, preferably ranging from 500 to about 3000 g/mol.
Item 11—The biobased TPU according to any one of items 1 to 10, wherein the biobased TPU has a biobased content of at least 90%.
Item 12—The biobased TPU according to any one of items 1 to 11, wherein the biobased TPU has a biobased content of from about 90% to about 95%, or from about 90% to about 96%, or from about 90% to about 97%, or from about 90% to about 98%, or from about 90% to about 99%, or from about 90% to about 100%.
Item 13—The biobased TPU according to any one of items 1 to 12, wherein the chain extender is selected from 1,3-PDO, butane diols, pentane diols, hexanediols, ethylene glycol, propylene glycol, Hydroquinone bis(2-hydroxyethyl) ether (HQEE), 1,3-bis(2-hydroxyethyl) resorcinol (HER), cyclohexane dimethanol (CHDM), 3-methyl-1,5-pentanediol, 2-butyl-2-ethyl-1,3-propanediol, and any combination thereof. The biobased TPU according to any one of items 1 to 13, wherein the chain extender is a Item 14-biobased chain extender.
Item 15—The biobased TPU according to any one of items 1 to 14, wherein the chain extender is selected from biobased 1,3-PDO and biobased 1,4-BDO.
Item 16—The biobased TPU according to any one of items 1 to 15, wherein the chain extender has an odd number of carbon atoms.
Item 17—The biobased TPU according to any one of items 1 to 16, wherein the chain extender is biobased 1,3-PDO.
Item 18—The biobased TPU according to any one of items 1 to 17, wherein the molar ratio of PDI to polyol to chain extender is from about 1.5:1:0.5 to about 4:1:3, preferably from about 1.5:1:0.5 to about 3:1:2, more preferably from 2:1:1 to 3:1:1.
Item 19—The biobased TPU according to any one of items 1 to 18, wherein the TPU is obtained by reacting an NCO-terminated prepolymer produced from the biobased monomeric PDI and the at least one polyol, with the at least one chain extender.
Item 20—The biobased TPU according to item 19, wherein the NCO-terminated prepolymer is produced by reacting the PDI and the polyol at 1.1:1 to 10:1 molar ratio under heating at a temperature ranging from about 50° C. to about 120° C.
Item 21—The biobased TPU according to item 19 or 20, wherein the NCO-terminated prepolymer is produced by reacting the PDI and the biobased polyol at a molar ratio of at least 2:1.
Item 22—The biobased TPU according to any one of items 19 to 21, wherein the NCO-terminated prepolymer is produced by mixing the PDI and the biobased polyol in the absence of any catalyst.
Item 23—The biobased TPU according to any one of items 19 to 22, wherein the NCO-terminated prepolymer is produced using a demoisturized biobased polyol.
Item 24—The biobased TPU according to item 23, wherein the demoisturized biobased polyol has a water content below 0.1 wt %, preferably below 0.06 wt % based on the weight of the polyol.
Item 25—The biobased TPU according to any one of items 19 to 24, wherein the NCO-terminated prepolymer has a biobased content of at least 90%.
Item 26—The biobased TPU according to any one of items 19 to 25, wherein the NCO-terminated prepolymer has a biobased content of from about 90% to about 95%, or from about 90% to about 96%, or from about 90% to about 97%, or from about 90% to about 98%, or from about 90% to about 99%, or from about 90% to about 100%.
Item 27—The biobased TPU according to any one of items 19 to 26, wherein the NCO-terminated prepolymer has a viscosity at 70° C. ranging from about 100 cps to about 10000 cps, preferably from about 500 cps to about 7000 cps.
Item 28—The biobased TPU according to any one of items 19 to 27, wherein the reaction of the NCO-terminated prepolymer with the chain extender is performed under heating with or without catalyst.
Item 29—The biobased TPU according to any one of items 1 to 28, wherein the TPU has a content of hard segment ranging from about 10 wt % to about 40 wt %.
Item 30—The biobased TPU according to item 1, obtained from pentamethylene diisocyanate (PDI) having a biobased content of at least 70% and biobased 1,3-PDO-sebacate polyester diol having a molecular weight of about 1000 g/mol, the chain extender is biobased 1,3-PDO, the molar ratio of PDI to biobased polyol to chain extender is about 2:1:1, and wherein the TPU has a content of hard segment from about 20 wt % to about 30 wt %.
Item 31—The biobased TPU according to item 30, wherein TPU has a content of hard segment from about 25 wt % to about 30 wt %.
Item 32—The biobased TPU according to item 1, obtained from pentamethylene diisocyanate (PDI) having a biobased content of at least 70% and biobased 1,3-PDO-sebacate polyester diol having a molecular weight of about 2000 g/mol, the chain extender is biobased 1,3-PDO, the molar ratio of PDI to biobased polyol to chain extender is about 2:1:1, and wherein the TPU has a content of hard segment from about 10 wt % to about 20 wt %.
Item 33—The biobased TPU according to item 32, wherein TPU has a content of hard segment from about 13 wt % to about 18 wt %.
Item 34—The biobased TPU according to any one of items 1 to 33, wherein the TPU is characterized by a tensile stress at break at room temperature of at least 3000 psi.
Item 35—The biobased TPU according to item 1, obtained from pentamethylene diisocyanate (PDI) having a biobased content of at least 70% and biobased 1,3-PDO-sebacate polyester diol, the chain extender is biobased 1,3-PDO, and wherein the TPU is characterized by a tensile stress at break at room temperature of at least 3000 psi.
Item 36—The biobased TPU according to any one of items 1 to 35, wherein the PDI has a biobased content of at least 71%.
Item 37-Use of the biobased TPU according to any one of items 1 to 36, in the production of footwear, pipes, tubes, hoses, rollers, wheels, gaskets, seals, hot melt adhesives, expandable TPUs, belts, wire coatings, metal coatings, pipe coatings, sieve coatings, laminates, tags, inflatables, textile coatings, garments, barrier films, sporting goods, or medical devices.
Item 38-A PDI-based elastomer obtained from a biobased monomeric pentamethylene diisocyanate (PDI) and at least one polyol selected from a polyester polyol, a polyether polyol, and a combination thereof, in the presence of at least one curative agent, wherein the PDI has a biobased content of at least 70%.
Item 39—The PDI-based elastomer according to item 38, wherein the PDI-based elastomer has a biobased content of from about 20% to about 100%.
Item 40—The PDI-based elastomer according to item 38 or 39, wherein the polyester polyol is a succinate based polyester diol, an adipate based polyester diol, a sebacate based polyester diol, an azelate based polyester diol, a 1,18-octadecanedioic diacid based polyester diol, or any combination thereof.
Item 41—The PDI-based elastomer according to any one of items 38 to 40, wherein the polyester polyol is optionally biobased and is synthesized from an organic diacid selected from succinic acid, adipic acid, sebacic acid, azelaic acid, a 1,18-octadecanedioic diacid, and any combination thereof, with a diol being selected from 1,4-Butanediol (1,4-BDO), 1,3-Propanediol (1,3-PDO), and a mixture thereof.
Item 42—The PDI-based elastomer according to any one of items 38 to 41, wherein the polyester polyol is selected from 1,4-BDO-adipate, 1,3-PDO-adipate, 1,4-BDO-Sebacate, 1,3-PDO-sebacate, and any combination thereof.
Item 43—The PDI-based elastomer according to any one of items 38 to 42, wherein the polyester polyol is 1,3-PDO-sebacate.
Item 44—The PDI-based elastomer according to any one of items 38 to 43, wherein the polyester polyol is a biobased polyester polyol.
Item 45—The PDI-based elastomer according to any one of items 38 to 44, wherein the polyether polyol is selected from polytrimethylene ether glycols (PO3G), polytetramethylene ether glycols (PTMEG or PTMG), polyethylene glycols, and any combination thereof.
Item 46—The PDI-based elastomer according to any one of items 38 to 45, wherein the polyether polyol comprises at least one polytetramethylene ether glycol (PTMEG or PTMG).
Item 47—The PDI-based elastomer according to any one of items 38 to 46, wherein the polyether polyol is a biobased polyether polyol.
Item 48—The PDI-based elastomer according to any one of items 38 to 47, wherein the polyester polyol and/or the polyether polyol has a biobased content of at least 99%.
Item 49—The PDI-based elastomer according to any one of items 38 to 48, wherein the polyol has a molecular weight of at least 500 g/mol, preferably ranging from 500 to about 10000 g/mol, more preferably ranging from 500 to about 3000 g/mol.
Item 50—The PDI-based elastomer according to any one of items 38 to 49, wherein the curative agent is selected from a sterically hindered amine, a diol, a polyol, a secondary diamine, a diamine ether oligomer, and any combination thereof.
Item 51—The PDI-based elastomer according to any one of items 38 to 50, wherein the curative agent comprises a sterically hindered diamine comprising an aromatic diamine with two primary amino groups, or with one primary amino group and one secondary amino group, or with two secondary amino groups.
Item 52—The PDI-based elastomer according to any one of items 38 to 51, wherein the curative agent comprises at least one sterically hindered diamine comprises an aromatic diamine.
Item 53—The PDI-based elastomer according to any one of items 38 to 52, wherein the curative agent comprises a Dimethyl thio-toluene diamine (DMTDA), a Diethyltoluene diamine (e.g., 3,5-Diethyltoluene-2,4-diamine, 3,5-Diethyltoluene-2,6-diamine or a mixture thereof), 4,4′-Methylene-bis(2-chloroaniline) (MOCA), or any mixture thereof.
Item 54—The PDI-based elastomer according to any one of items 38 to 53, wherein the elastomer is obtained by reacting an NCO-terminated prepolymer produced from the biobased monomeric PDI and the at least one polyol, with the at least one curative agent.
Item 55—The PDI-based elastomer according to item 54, wherein the curative agent is reacted with the NCO-terminated prepolymer in a molar ratio NCO-terminated prepolymer to curative agent of about 0.95:1 to about 1.10:1, preferably about 1.05:1.
Item 56—The PDI-based elastomer according to items 54 or 55, wherein the NCO-terminated prepolymer is produced by reacting the PDI and the polyol under heating at a temperature ranging from about 50° C. to about 120° C.
Item 57—The PDI-based elastomer according to any one of items 54 to 56, wherein the NCO-terminated prepolymer is produced by mixing the PDI and the biobased polyol in the absence of any catalyst.
Item 58—The PDI-based elastomer according to any one of items 54 to 57, wherein the NCO-terminated prepolymer is produced using a demoisturized polyol.
Item 59—The PDI-based elastomer according to item 58, wherein the demoisturized polyol has a water content below 0.1 wt %, preferably below 0.06 wt % based on the weight of the polyol.
Item 60—The PDI-based elastomer according to any one of items 54 to 59, wherein the NCO-terminated prepolymer has a viscosity at 70° C. ranging from about 100 cps to about 10000 cps, preferably from about 500 cps to about 10000 cps.
Item 61—The PDI-based elastomer according to any one of items 54 to 60, wherein the reaction of the NCO-terminated prepolymer with the at least one sterically hindered diamine is performed under heating with or without catalyst.
Item 62—The PDI-based elastomer according to any one of items 38 to 61, wherein the molar ratio of PDI to polyol is at least 1.1:1, preferably from 1.1:1 to 10:1, more preferably from 1.5:1 to 4:1, and even more preferably from 2:1 to 3:1.
Item 63—The PDI-based elastomer according to any one of items 38 to 62, wherein the PDI-based elastomer presents a hardness higher than a hardness of an Isophorone diisocyanate-based elastomer (IPDI-based elastomer) and the PDI-based elastomer presents a resilience that is higher than a resilience of the IPDI-based elastomer where the IPDI-based elastomer is prepared using the same polyol, same curative agent and in the same molar ratio and the same conditions as the PDI-based elastomer.
Item 64—The PDI-based elastomer according to item 63, wherein the resilience of the PDI-based elastomer is at least 1.2 times higher than the resilience of the IPDI-based elastomer.
Item 65—The PDI-based elastomer according to any one of items 38 to 64, wherein the PDI-based elastomer presents a tensile strength at break at room temperature higher than a tensile strength at break at room temperature of an IPDI-based elastomer and the PDI-based elastomer presents an elongation at break at room temperature that is higher than an elongation at break at room temperature of the IPDI-based elastomer, where the IPDI-based elastomer is prepared using the same polyol, same curative agent and in the same molar ratio and conditions as the PDI-based elastomer.
Item 66—The PDI-based elastomer according to item 65, wherein the tensile strength at break at room temperature of the PDI-based elastomer is at least 1.8 times higher than the tensile strength at break at room temperature of the IPDI-based elastomer.
Item 67—The PDI-based elastomer according to any one of items 38 to 66, wherein the PDI-based elastomer presents an abrasion resistance higher than an abrasion resistance of an IPDI-based elastomer, where the IPDI-based elastomer is prepared using the same polyol, same curative agent and in the same molar ratio and conditions as the PDI-based elastomer.
Item 68—The PDI-based elastomer according to any one of items 38 to 67, wherein the PDI-based elastomer presents a tear strength higher than a tear strength of an IPDI-based elastomer, where the IPDI-based elastomer is prepared using the same polyol, same curative agent and in the same molar ratio and conditions as the PDI-based elastomer.
Item 69—The PDI-based elastomer according to any one of items 38 to 68, wherein the PDI has a biobased content of at least 71%.
Item 70—Use of the PDI-based elastomer according to any one of items 38 to 69, in the production of footwear (e.g., shoe sole), liners, metal coatings, pump seals, rod wipers, snow plough blades, valves, wheels, tires, agitator blades, rollers, rolls, gaskets, seals, pulleys, bumpers, shock absorbers, bushings, bearings, wear strips, slide plates, machine parts, housings, escalator parts, couplings, fixture blocks, grommets, hammers, striker pads, wood-sorter pads, gears, or sprockets.
Item 71—The biobased TPU according to any one of items 1 to 36, the PDI-based elastomer according to any one of items 38 to 69, or the use according to item 37 or 70, wherein the PDI is obtained by a process comprising:
   subjecting a solution comprising a cadaverine salt dissolved in an inert solvent in the presence of a tertiary amine base, to a liquid-phase phosgenation reaction using a phosgene source, to convert the cadaverine to PDI,
   wherein the phosgenation reaction comprises a step of maintaining the reaction at a temperature range between 100° C. and 120° C. for a sufficient time to achieve a desired threshold yield of PDI,
   wherein the tertiary amine base is present in an amount to enable the phosgenation reaction to occur to completion at said temperature range.
Item 72—The biobased TPU, the PDI-based elastomer, or the use according to item 71, wherein said sufficient time is at least 1.5 hours.
Item 73—The biobased TPU, the PDI-based elastomer, or the use according to item 71 or 72, wherein the phosgenation reaction is a multistage phosgenation reaction comprising at least a first stage in which the solution is heated to a first temperature such that the cadaverine reacts with phosgene from the phosgene source to produce a dicarbamoyl chloride intermediate, and a subsequent second stage in which the solution is further heated to a second temperature higher than the first temperature to subject the dicarbamoyl chloride intermediate to dehydrochlorination, wherein the second stage comprises said step of maintaining the reaction at temperatures between 100° C. and 120° C. for a sufficient time to achieve a threshold yield of PDI.
Item 74—The biobased TPU, the PDI-based elastomer, or the use according to item 73, wherein the first temperature is from about 30 to about 65° C.
Item 75—The biobased TPU, the PDI-based elastomer, or the use according to item 73 or 74, wherein the first stage comprises maintaining the solution at the first temperature for at least 0.5 hours.
Item 76—The biobased TPU, the PDI-based elastomer, or the use according to any one of items 73 to 75, wherein the second temperature is higher than the first temperature by at least 10° C.
Item 77—The biobased TPU, the PDI-based elastomer, or the use according to any one of items 71 to 76, wherein the process employs 3 to 30 mols of phosgene per mole of cadaverine salt.
Item 78—The biobased TPU, the PDI-based elastomer, or the use according to any one of items 71 to 77, wherein the process employs at least 4 mols of tertiary amine base per mole of cadaverine salt.
Item 79—The biobased TPU, the PDI-based elastomer, or the use according to any one of items 71 to 78, wherein the cadaverine salt is obtained from fermentation and/or enzymatic conversion, and a content of 2,3,4,5-tetrahydropyridine (THP) or other cyclic by-product impurity in the cadaverine salt is below 0.1 wt %.
Item 80—The biobased TPU, the PDI-based elastomer, or the use according to any one of items 71 to 79, wherein the cadaverine salt is cadaverine dihydrochloride.
Item 81—The biobased TPU, the PDI-based elastomer, or the use according to any one of items 71 to 80, wherein the phosgene source is triphosgene and the tertiary amine base is reacted with the triphosgene to release phosgene for the phosgenation reaction.
Item 82—The biobased TPU, the PDI-based elastomer, or the use according to any one of items 71 to 81, wherein the tertiary amine base is a heterocyclic amine or a tertiary amine base having a sp²-hybridized N atom.
Item 83—The biobased TPU, the PDI-based elastomer, or the use according to any one of items 71 to 82, wherein the tertiary amine base is pyridine.
Item 84—The biobased TPU, the PDI-based elastomer, or the use according to any one of items 71 to 83, wherein the inert solvent comprises or consists of chlorobenzene, dichlorobenzene, toluene, nitrobenzene, or any mixture thereof.
Item 85—The biobased TPU, the PDI-based elastomer, or the use according to any one of items 71 to 84, wherein the inert solvent is a solvent or solvent mixture having a boiling point of at least 120° C.
Item 86—The biobased TPU, the PDI-based elastomer, or the use according to any one of items 71 to 85, wherein the PDI produced has a content of THP or other cyclic by-product impurity of below 0.1 wt % before being subject to one or more distillation steps.
Item 87—The biobased TPU, the PDI-based elastomer, or the use according to any one of items 71 to 86, wherein the desired threshold yield of PDI is at least 50%.

### EXAMPLES

### Example 1: PDI-Based Thermoplastic Polyurethanes

Thermoplastic polyurethanes (TPUs) were prepared from biobased PDI and polyether polyol or polyester polyol and characterized for their physico-chemical properties. Different polyols and chain extenders were tested.

### Example 1.1: Preparation and Properties of PDI-Based TPUs Prepared with Various Polyols and 1,3-PDO as Chain Extender

### Materials and Methods

### Chemicals

The chemicals used in this study are listed in Table 1. As needed, PO3G polyether polyols of 1000 and 2000 MW, PDO-sebacate polyester polyols of 1000 and 2000 MW, and PDO were demoisturized at 75-80° C. under vacuum of 1-3 mm Hg and continuous mixing by magnetic stirrer to reduce water content to be ≤0.06 wt. %. The water content was confirmed via Karl Fisher Titrator (ASTM D 4672).

PDI was used as received. Prior to use, the isocyanate content can be checked by di-n-butylamine titration method (ASTM D-5155).

TABLE 1
Materials

| Component Name | Description | Supplier |
|---|---|---|
| PDO Sebacate 2000 | PDO-sebacate polyester polyol; | Specialty Resins |
| | 2000-molecular weight; Fn = 2 | |
| PDO Sebacate 1000 | PDO-sebacate polyester polyol; | Specialty Resins |
| | 1000-molecular weight; Fn = 2 | |
| PO3G 2000 | Velvetol ™ H2000; PO3G polyether polyol; | Allessa |
| | 2000-molecular weight; Fn = 2 | |
| PO3G 1000 | Velvetor ™ H1000; PO3G polyether polyol; | Allessa |
| | 1000-molecular weight; Fn = 2 | |
| 1,3-PDO | Susterra ™ 1,3-propane diol | DuPont |
| Dabco ™ T-12 | Dibutyltin dilaurate gel catalyst | Evonik |
| PDI | Bio-based 1,5-pentamethylene diisocyanate; | Mojia Biotech |
| | NCO % = 53.2%, 78.95 equivalent weight. | |

### Preparation of NCO-Prepolymers

The NCO-terminated prepolymers were produced from PDI diisocyanate and relevant polyols at NCO/OH equivalent ratio of about 2/1 (Table 2). The syntheses of prepolymers were completed in a 1-L glass reactor equipped with an overhead stirrer, nitrogen sweep, and temperature-controlled heating mantle. When the temperature of the isocyanate reaches 75° C., the polyol was added slowly while maintaining the temperature at ≤80° C. The reaction was monitored by measuring the NCO % concentration per ASTM D5155. When close to the theoretical NCO % was reached, the reaction mixture was cooled. The prepolymer can be stored in a sealed glass container under nitrogen at room temperature.

The formulations of NCO-prepolymer based on PDI and PDO-sebacate polyester polyols of 1000 and 2000 MW and PO3G polyether polyols of 1000 and 2000 MW are outlined in Table 2. Renewable content for each NCO-prepolymer is presented along with viscosity and melt transition.

TABLE 2
PDI prepolymer syntheses with sustainable polyols

| | | PDI/S1000 | PDI/S2000 | PDI/P1000 | PDI/P2000 |
|---|---|---|---|---|---|
| Prepolymer Designation | | PP* | PP* | PP* | PP* |
| Batch Size (g) | | 700 | 700 | 700 | 700 |
| Components | Eq. Wt | | | | |
| PDO−Seb 1000 | 497.78 | 529.31 | — | — | — |
| PDO−Seb 2000 | 992.92 | — | 600.29 | — | — |
| PO3G 1000 | 525.92 | — | — | 541.63 | — |
| PO3G 2000 | 960.62 | — | — | — | 600.05 |
| PDI (first batch) | 79.37 | 169.25 | 96.53 | 162.33 | — |
| PDI (second batch) | 77.58 | — | — | — | 97.35 |
| Total Mass (g) | | 698.56 | 696.82 | 703.96 | 697.40 |
| Properties | | | | | |
| NCO/OH Ratio | | 2.00 | 2.00 | 2.00 | 2.00 |
| Theoretical NCO % | | 6.40 | 3.65 | 6.13 | 3.76 |
| End of Reaction NCO % | | 6.54 | 3.33 | 6.77 | 4.06 |
| Final NCO % | | 6.28 | 3.19 | 6.04 | 3.46 |
| Viscosity @ 70° C., mPas | | 1240 | 6310 | 495 | 1050 |
| Melt transition via DSC, ° C. | | 49.98 | 56.71 | 10.21 | 17.98 |
| Renewable content, % | | 93 | 96 | 93 | 96 |

Notes:
** NCO % checked prior to making sheets. Syntheses carried out at 80° C. under nitrogen blanket. PDI prepolymers solid at room temperature.
*PP = prepolymer

### Preparation and Testing of TPUs

TPUs were prepared by reacting PDI NCO-terminated prepolymers with sustainable Susterra™ 1,3-PDO chain extender at isocyanate index of 1.02 (Table 3 and 4).

NCO-prepolymers preheated at 80° C. and dry 1,3-PDO chain extender with catalyst were weighed into a cup and mixed for 45 seconds at 2200 rpm using a multi-axial mixer (Speed Mixer, Flack Tek Inc.). Afterwards, the mixture was transferred into an aluminum mold covered with Teflon™ sheet preheated at 120° C. At gel time, the mold was closed and TPU cured for 2 hours at 120° C. Afterwards, the samples were post-cured for 16 hours at 100° C. in an air-circulation oven.

After post-curing, the samples were aged for seven days at room conditions prior to testing. TPUs were analyzed via FTIR to confirm absence of unreacted isocyanate associated with a signal at 2270 cm-1.

The following is the list of tests performed on aged TPU samples.
Hardness at room temperature, ASTM D-2240, Shore A and Shore D
Resilience (Bashore rebound), ASTM D2632 (Bashore Resiliometer)
Tensile stress-strain properties (tensile strength, elongation at break, modulus, tensile set, toughness), ASTM D412 (Instron™ 5500R, Model 1122)
Heat resistance: Tensile strength up to 400% extension @50° C., ASTM D412 (Instron™ 5500R, Model 1122 with Heat Chamber)·
Tear Strength—Graves Die C, ASTM D624, (Instron™ 5500R, Model 1122)·
Compressive strength, ASTM D 695
Compression set at 70° C., ASTM D-395
Hydrolytic resistance, Stress-strain properties upon hydrolytic aging 50 C, 5 days, 95% relative humidity
Solvent resistance, Weigh change upon immersion in various solvents for 3 days (water, IPA, oil, MEK)
Chemical Characterization, FTIR analysis: FTIR Spectrometer (Spectrum Two, Perkin Elmer with Pike Miracle ATR Attachment)
Thermal performance, Differential Scanning calorimetry (DSC)
Thermal performance, Dynamic Mechanical Analyses (DMA).

### Results and Discussion

### NCO Prepolymers

NCO-prepolymers were prepared at 2/1 isocyanate to polyols equivalent ratio with PDI isocyanate using PO3G 1000, PO3G 2000, PDO-sebacate 1000, and PDO-sebacate 2000. The formulations of prepolymers and basic parameters in synthesis are presented in Table 2. No catalyst was added in PDI NCO-prepolymer syntheses. All prepolymers were obtained at isocyanate content close to theoretical.

The viscosity of PDI prepolymers based on PO3G polyether polyols is significantly lower than for PDI prepolymers based on PDO-sebacate polyols. However, the viscosity of NCO-prepolymers at 70° C. is relatively low, which is convenient in processing (Table 2).

DSC analyses of PDI prepolymers based on PDO-sebacate polyester polyols of 1000 and 2000 MW show crystalline melt transition at 50 and 57° C., respectively (Table 2). DSC analyses of PDI prepolymers based on PO3G 1000 and 2000 MW show the crystalline melt transitions at 10 and 18° C., respectively (Table 2). As a result, PDI prepolymers based on PO3G polyether polyols were liquid at room temperatures while PDI prepolymers based on PDO-sebacate polyols were solid.

### Thermoplastic Polyurethanes

TPUs were prepared from PDI prepolymers reacted with 1,3-PDO chain extender at 1.02 isocyanate index under the same conditions (Tables 3 and 4). A small amount of tin-catalyst was used in formulation to facilitate polymerization, which is typically required in aliphatic isocyanate based TPUs.

The TPUs produced from PDI prepolymer have very high renewable content ranging from 93 to 96 wt. %.

TPUs based on PDI prepolymer produced from 1000 MW PO3G or PDO-sebacate polyols have hard segment of 28% while those produced from 2000 MW PO3G or PDO-sebacate polyols have hard segment of about 16%. The hard segment values are relatively low compared to conventional di-isocyanate (e.g., 4,4′-MDI) prepared with the same equivalent ratio of isocyanate/polyol/chain extender. Low hard segment can be attributed to the fact that PDI has the lowest molecular weight of the currently commercially available diisocyanates. However, the hard segment concentration in the TPUs can be increased, if needed, by producing higher NCO quasi-prepolymers from PDI which would require higher concentration of chain extender in the syntheses of TPUs.

FTIR analysis of TPUs shows no significant absorption related to free NCO-groups at 2270 cm-1, indicating completion of polyurethane polymerization.

Overall TPUs produced from PDI prepolymer based on PDO-sebacate polyols appear stronger and more uniform that the corresponding TPUs produced from PDI prepolymers based on PO3G polyols at the same hard segment concentration. In general, TPUs based on polyester polyols are stronger than those based on polyether polyols. PDI TPUs based on PO3G polyols can be further optimized with potential selection of different chain extenders (e.g., BDO, HQEE, cyclohexane dimethanol (CHDM)). Similar performance is expected for TPUs produced via single step reaction between PDI, polyols, and chain extenders.

PDI TPUs based on 1000 MW polyols, both polyester and polyether, exhibit relatively high resilience. PDI TPUs based on 2000 MW polyols exhibit lower crystallinity, due to higher soft segment crystallinity, which reduce the dynamic properties (Table 5). Physico-mechanical properties of TPUs are presented in Tables 5A and 5B.

DSC analyses of TPU produced from PDI prepolymer based on 1000 MW PDO-sebacate polyol show small level of crystallinity with melt transition at 28° C. (Table 5A), which is substantially attenuated compared to the corresponding prepolymer. TPU produced from PDI prepolymer based on 2000 MW PDO-sebacate polyol shows higher level of crystallinity with melt transition at 47° C. (Table 5A).

On the other hand, TPUs produced from PDI prepolymer based on PO3G polyols of 1000 MW shows no crystallinity associated with the soft segment. TPU produce from PDI prepolymer based on PO3G polyols of 2000 MW showed notable crystalline domain however with low melt transition temperature at approximately 14° C. (Table 5A). DMA analysis also shows that TPU based on PDI and on PDO-sebacate polyols have higher melt transition than the corresponding TPUs based on PO3G polyols.

The following is the summary of key physico-mechanical properties of TPUs, which are presented in Tables 5A and 5B:
TPUs based on PDI prepolymer based on PDO-sebacate polyester polyols exhibited higher hardness than those based on PO3G polyether polyols. TPUs based on polyester polyols typically have higher hardness.
PDI TPUs with higher hard segment content, i.e., based on PO3G polyols, have higher hardness, which is typically the case for TPUs based on polyols. However, it is the crystallinity of PDI TPUs based on PDO-sebacate of 2000MW that correlates with the enhanced hardness of TPUs over the PDI TPU based on PDO-sebacate of 1000MW.
Tensile strength and modulus of polyester TPUs based on PDO-sebacate polyols is higher than that of polyether TPUs, which is usually the case when comparing polyester and polyether based TPUs. PDI TPUs based on PDO-sebacate polyols also have high toughness, as determined by the area under tensile stress-stain curves. This should translate into good wear resistance of these PDI TPUs.
Tear strength of PDI TPU based on PDO-sebacate polyols is higher compared to PDI TPUs based on PO3G polyols, which can be correlated with their excellent tensile properties.
Compressive strength and modulus of polyester TPUs based on PDO-sebacate polyols is higher than that of polyether TPUs.
Compressive set (permanent deformation) is also lower for PDI TPUs based on PDO-sebacate polyols compared with those based on PO3G polyols.
The heat resistance of PDI TPUs is measured as retention of tensile properties at 50° C. (Table 5B). Retention on tensile modulus for PDI TPUs is lower for those based on 2000 MW compared to 1000 MW PDO-sebacate polyols.
All PDI TPUs exhibited excellent retention of properties upon hydrolytic aging (Table 5B). This is especially important for polyester TPUs evaluated, which are in general more susceptible to moisture than polyether TPUs. This could be attributed to good hydrolytic resistance of PDO-sebacate polyester polyol.
All PDI TPUs exhibited comparable resistance to water and oil. However, it is interesting that PDI TPUs based on PDO-sebacate polyester polyol actually had lower water absorption that PDI TPU based on PO3G polyether polyol. Also, PDI TPUs based on PDO-sebacate polyester polyol had higher resistance to polar and non-polar solvents than PDI TPUs based on PO3G polyols of corresponding molecular weights.

TABLE 3
TPU Syntheses with PDI Prepolymers and 1,3 PDO chain extender

| | | Formulation | | | | | | | | |
|---|---|---|---|---|---|---|---|---|---|---|
| | | | | | | | | | | PDI/ |
| | Eq. | PDI/S1000 | | | | | | | | S2000 |
| Components | Wt. | S1 | S2 | S3 | S4 | S5 | S6 | B | B2 | S1 |
| PDI/S1000 PP | 668.79 | 56.87 | 61.65 | 61.61 | 61.65 | 61.63 | 61.65 | 61.61 | 61.59 | — |
| PDI/S2000 PP | 1316.61 | — | — | — | — | — | — | — | — | 63.32 |
| 1,3 Propanediol | 38.05 | 1.50 | 1.79 | 1.79 | 1.77 | 1.79 | 1.80 | 1.80 | 1.82 | 0.17 |
| (Zemea) | | | | | | | | | | |
| 3% Dabco ™ | — | 1.67 | 1.68 | 1.66 | 1.66 | 1.66 | 1.63 | 1.64 | 1.63 | 1.63 |
| T-12 in | | | | | | | | | | |
| 1,3-PDO | | | | | | | | | | |
| Dabco ™ T-12 | — | 0.05 | 0.05 | 0.05 | 0.05 | 0.05 | 0.05 | 0.05 | 0.05 | 0.05 |
| (Actual | | | | | | | | | | |
| amount) | | | | | | | | | | |

| Total Mass, g | 60 | 65 | | | | | | | 65 |
|---|---|---|---|---|---|---|---|---|---|
| Isocyanate Index | 1.02 | | | | | | | | 1.02 |
| Hard Segment, % | 28 | | | | | | | | 16 |
| Renewable Content, % | 93 | | | | | | | | 96 |
| Side B temp (pre-mix), ° C. | 80 | | | | | | | | 80 |
| Side A temp (pre-mix), ° C. | 80 | | | | | | | | 80 |
| Time in oven before | 15 | | | | | | | | 15 |
| mixing, min | | | | | | | | | |
| Speed mix time, s | 20 | | | | | | | | 20 |
| Gel time, s | 56 | 58 | 51 | 46 | 50 | 44 | — | — | 120 |

| | | |
|---|---|---|
| Sample Comments: | Transparent, very tough | More |
| | | opaque, |
| | | very |
| | | tough |

| | | Formulation | | | | | | |
|---|---|---|---|---|---|---|---|---|
| | Eq. | PDI/S2000 | | | | | | |
| Components | Wt. | S2 | S3 | S4 | S5 | S6 | B | B2 |
| PDI/S1000 PP | 668.79 | — | — | — | — | — | — | — |
| PDI/S2000 PP | 1316.61 | 63.33 | 63.36 | 63.19 | 63.37 | 63.18 | 63.31 | 63.35 |
| 1,3 Propanediol | 38.05 | 0.17 | 0.17 | 0.18 | 0.11 | 0.12 | 0.12 | 0.09 |
| (Zemea) | | | | | | | | |
| 3% Dabco ™ | — | 1.64 | 1.63 | 1.63 | 1.67 | 1.67 | 1.67 | 1.69 |
| T-12 in | | | | | | | | |
| 1,3-PDO | | | | | | | | |
| Dabco ™ T-12 | — | 0.05 | 0.05 | 0.05 | 0.05 | 0.05 | 0.05 | 0.05 |
| (Actual | | | | | | | | |
| amount) | | | | | | | | |

| Total Mass, g | 65 | | | | | | |
|---|---|---|---|---|---|---|---|
| Isocyanate Index | 1.02 | | | | | | |
| Hard Segment, % | 16 | | | | | | |
| Renewable Content, % | 96 | | | | | | |
| Side B temp (pre-mix), ° C. | 80 | | | | | | |
| Side A temp (pre-mix), ° C. | 80 | | | | | | |
| Time in oven before | 15 | | | | | | |
| mixing, min | | | | | | | |
| Speed mix time, s | 20 | | | | | | |
| Gel time, s | 110 | 103 | 109 | 110 | 103 | — | — |

| | |
|---|---|
| Sample Comments: | More opaque, very tough |

Notes:
Italicized numbers = not added directly (added via solution)

TABLE 4
TPU Syntheses with PDI Prepolymers and 1,3 PDO chain extender

| | | Formulation | | | | | | | | |
|---|---|---|---|---|---|---|---|---|---|---|
| | | PDI/P1000 | | | | | | | | PDI/P2000 |
| Components | Eq. Wt. | S1 | S2 | S3 | S4 | S5 | S6 | B | B2 | S1 |
| PDI/P1000 PP | 695.36 | 61.89 | 61.73 | 61.82 | 61.73 | 61.79 | 61.82 | 61.84 | 61.70 | — |
| PDI/P2000 PP | 1213.87 | — | — | — | — | — | — | — | — | 63.10 |
| 1,3 Propanediol | 38.05 | 1.64 | 1.64 | 1.67 | 1.66 | 1.65 | 1.62 | 1.64 | 1.63 | 0.26 |
| (Zemea) | | | | | | | | | | |
| 3% Dabco ™ | — | 1.67 | 1.67 | 1.65 | 1.67 | 1.68 | 1.69 | 1.67 | 1.68 | 1.68 |
| T-12 in | | | | | | | | | | |
| 1,3-PDO | | | | | | | | | | |
| Dabco ™ T-12 | — | 0.05 | 0.05 | 0.05 | 0.05 | 0.05 | 0.05 | 0.05 | 0.05 | 0.05 |
| (Actual | | | | | | | | | | |
| amount) | | | | | | | | | | |

| Total Mass, g | 65 | | | | | | | | 65 |
|---|---|---|---|---|---|---|---|---|---|
| Isocyanate Index | 1.02 | | | | | | | | 1.02 |
| Hard Segment, % | 27 | | | | | | | | 16 |
| Renewable Content, % | 93 | | | | | | | | 96 |
| Side B temp (pre-mix), ° C. | 80 | | | | | | | | 80 |
| Side A temp (pre-mix), ° C. | 80 | | | | | | | | 80 |
| Time in oven | 15 | | | | | | | | 15 |
| before mixing, min | | | | | | | | | |
| Speed mix time, s | 20 | | | | | | | | 20 |
| Gel time, s | 47 | 53 | 51 | 48 | 42 | 44 | — | — | 62 |

| Sample Comments: | Sheets very sticky and flexible | Sheets very sticky and flexible |
|---|---|---|
| | immediately after removal from | immediately after removal from |
| | oven. Cooling to room temperature | oven. Cooling to room temperature |
| | makes it less tacky and firmer. | makes it less tacky and firmer. |

| | | Formulation | | | | | | |
|---|---|---|---|---|---|---|---|---|
| | | PDI/P2000 | | | | | | |
| Components | Eq. Wt. | S2 | S3 | S4 | S5 | S6 | B | B2 |
| PDI/P1000 PP | 695.36 | — | — | — | — | — | — | — |
| PDI/P2000 PP | 1213.87 | 63.14 | 63.15 | 63.07 | 63.16 | 63.14 | 63.18 | 63.20 |
| 1,3 Propanediol | 38.05 | 0.28 | 0.26 | 0.29 | 0.29 | 0.27 | 0.27 | 0.29 |
| (Zemea) | | | | | | | | |
| 3% Dabco ™ | — | 1.66 | 1.67 | 1.66 | 1.67 | 1.67 | 1.68 | 1.67 |
| T-12 in | | | | | | | | |
| 1,3-PDO | | | | | | | | |
| Dabco ™ T-12 | — | 0.05 | 0.05 | 0.05 | 0.05 | 0.05 | 0.05 | 0.05 |
| (Actual | | | | | | | | |
| amount) | | | | | | | | |

| Total Mass, g | 65 | | | | | | |
|---|---|---|---|---|---|---|---|
| Isocyanate Index | 1.02 | | | | | | |
| Hard Segment, % | 16 | | | | | | |
| Renewable Content, % | 96 | | | | | | |
| Side B temp (pre-mix), ° C. | 80 | | | | | | |
| Side A temp (pre-mix), ° C. | 80 | | | | | | |
| Time in oven | 15 | | | | | | |
| before mixing, min | | | | | | | |
| Speed mix time, s | 20 | | | | | | |
| Gel time, s | 53 | 65 | 73 | 120 | 124 | — | — |

| | |
|---|---|
| Sample Comments: | Sheets very sticky and flexible immediately after |

removal from oven. Cooling to room temperature
makes it less tacky and firmer.
Notes:
Italicized numbers = not added directly (added via solution)

TABLE 5A
TPU Properties

| Formulation | PDI/S1000 | PDI/S2000 | PDI/P1000 | PDI/P2000 |
|---|---|---|---|---|
| Isocyanate Index | 1.02 | 1.02 | 1.02 | 1.02 |
| Hard Segment, % | 28 | 16 | 27 | 16 |
| Renewable Content, % | 93 | 96 | 93 | 96 |
| Properties | | | | |
| Hardness, Shore A | 89.5 ± 1.3 | 91.4 ± 5.6 | 74.1 ± 2.1 | 47.3 ± 1.9 |
| Hardness, Shore D | 36.9 ± 1.4 | 43.4 ± 1.1 | 20.8 ± 0.4* | — |
| Resilience, Bashore rebound, % | 49.5 ± 4.5 | 34.5 ± 3.4 | 47.0 ± 3.7 | 37.2 ± 1.7 |
| Tensile stress-strain | | | | |
| Stress at break, psi | 3201 ± 271 | 4041 ± 203 | — | 746 ± 65 |
| Stress at 100% elongation, psi | 798 ± 22 | 816 ± 34 | 398 ± 10 | 154 ± 19 |
| Stress at 300% elongation, psi | 1195 ± 41 | 1275 ± 39 | 482 ± 14 | 176 ± 20 |
| Elongation at break, % | 830 ± 43 | 928 ± 29 | 1252 ± 154** | 1563 ± 94 |
| Toughness (area under stress-strain), J | 29.12 ± 3.48 | 37.19 ± 2.26 | — | 10.90 ± 1.24 |
| Tear Strength, Die C, N/cm | 979 ± 73 | 1020 ± 19 | 584 ± 29 | 213 ± 3 |
| Compressive Strength, 5% strain, psi | 86 ± 16 | 127 ± 42 | 88 ± 5 | 15 ± 4 |
| Compressive Strength, 10% strain, psi | 299 ± 48 | 531 ± 70 | 185 ± 12 | 58 ± 8 |
| Compressive Strength, 15% strain, psi | 574 ± 54 | 945 ± 28 | 281 ± 16 | 94 ± 7 |
| Compressive Strength, 20% strain, psi | 841 ± 70 | — | 365 ± 20 | 126 ± 10 |
| Compression Set, 22 h @ 70° C., % change | −8.7 ± 1.6 | −3.9 ± 0.7 | −16.0 ± 1.8 | −19.7 ± 2.3 |
| Isopropanol Resistance (Mass change), % | 25 ± 1 | 12 ± 0 | 96 ± 3 | 214 ± 18 |
| MEK Resistance (Mass change), % | 98 ± 1 | 323 ± 7 | 190 ± 2 | 429 ± 32 |
| Oil Resistance (Mass change), % | 0.3 ± 0.1 | 0.5 ± 0.2 | 1.2 ± 0.4 | 0.9 ± 0.1 |
| Water Resistance (Mass change), % | 1.3 ± 0.0 | 1.0 ± 0.0 | 5.1 ± 0.0 | 6.8 ± 0.1 |
| DSC, Tm ° C. | 28 | 47 | — | 14 |
| DMA, T_{g} by maximum tangent Δ, ° C. | −29 | −20 | −52 | −50 |

Note:
*Shore D gauge needle pierces surface of button, inaccurate reading
**Specimens slip out of grips before break, reported value is average elongation before slip

TABLE 5B
TPU Tensile Properties Under Different Conditions

| Formulation | PDI/S1000 | PDI/S2000 | PDI/P1000 | PDI/P2000 |
|---|---|---|---|---|
| Isocyanate Index | 1.02 | 1.02 | 1.02 | 1.02 |
| Room Temperature | | | | |
| Stress at break, psi | 3201 ± 271 | 4041 ± 203 | — | 746 ± 65 |
| Stress at 100% elongation, psi | 798 ± 22 | 816 ± 34 | 398 ± 10 | 154 ± 19 |
| Stress at 300% elongation, psi | 1195 ± 41 | 1275 ± 39 | 482 ± 14 | 176 ± 20 |
| Elongation at break, % | 830 ± 43 | 928 ± 29 | 1252 ± 154** | 1563 ± 94 |
| Toughness (area under stress-strain curve), J | 29.12 ± 3.48 | 37.19 ± 2.26 | — | 10.90 ± 1.24 |
| 50° C. | | | | |
| Stress at 100% elongation, psi | 492 ± 29 | 124 ± 8 | 215 ± 6 | 88 ± 10 |
| Retention of RT value, % | 61.7 | 15.2 | 54.0 | 57.1 |
| Stress at 300% elongation, psi | 692 ± 35 | 158 ± 11 | 214 ± 5 | 83 ± 5 |
| Retention of RT value, % | 57.9 | 12.4 | 44.4 | 47.2 |
| After 5 days @ 50° C. and 95% RH | | | | |
| Stress at break, psi | 2685 ± 277 | 3287 ± 135 | — | 663 ± 69 |
| Retention of RT value, % | 83.9 | 81.3 | — | 88.9 |
| Stress at 100% elongation, psi | 835 ± 47 | 1041 ± 43 | 360 ± 8 | 130 ± 12 |
| Retention of RT value, % | 104.6 | 127.6 | 90.5 | 84.4 |
| Stress at 300% elongation, psi | 1174 ± 60 | 1524 ± 39 | 478 ± 15 | 162 ± 7 |
| Retention of RT value, % | 98.2 | 119.5 | 99.2 | 92.0 |
| Elongation at break, % | 898 ± 39 | 896 ± 35 | — | 1528 ± 98 |
| Retention of RT value, % | 108.2 | 96.6 | — | 97.8 |
| Toughness (area under stress-strain curve), J | 28.49 ± 2.83 | 34.44 ± 2.49 | — | 9.16 ± 1.42 |
| Retention of RT value, % | 97.8 | 92.6 | — | 84.0 |

### Example 1.2: Preparation of Additional PDI-Based TPUs Prepared with PTMEG 1000 and BDO Adipate 1000 Polyols

### Materials and Methods

### Chemicals

The chemicals used in this example are listed in Table 6. PTMEG 1000, BDO Adipate 1000, and 1,4-butanediol (BDO) were demoisturized for 24 hours at 75-80° C. under vacuum of 1-3 mm Hg and continuous mixing by magnetic stirrer prior to being used. The water content of polyols used for preparation of NCO-prepolymers was ≤0.06 wt. %. The water content after drying was checked by Karl Fisher Titrator.

Isocyanates were used as received from the suppliers. Prior to use, the isocyanate content was checked by di-n-butylamine titration method.

TABLE 6
Materials

| Component Name | Description | Supplier |
|---|---|---|
| PTMEG 1000 | Polyether polyol; 1000-molecular weight; | Covestro |
| | Fn = 2, OH# = 105.6 mg/g KOH, | |
| | 531.25 equivalent weight | |
| Piothane ™ 1000 BA | Polyester polyol; 1000-molecular weight; | Specialty Resins |
| | Fn = 2, OH# = 112.9 mg/g KOH, | |
| | 496.90 equivalent weight | |
| 1,4 Butanediol | Aliphatic diol chain extender | Sigma Aldrich |
| | OH# = 45 mg/g KOH | |
| Dabco ™ T-12 | Dibutyltin dilaurate gel catalyst | Evonik |
| PDI | Biobased 1,5-pentamethylene diisocyanate; | Mojia Biotech |
| | NCO% = 53.2%, 78.95 equivalent weight. | |

### NCO-Prepolymers

The NCO-terminated prepolymers were produced from PDI diisocyanate with PTMEG 1000 and BDO-Adipate 1000 polyols at NCO/OH equivalent ratio of about 2/1. The syntheses of prepolymers were completed in a 1-L glass reactor equipped with an overhead stirrer, nitrogen sweep, and temperature-controlled heating mantle. When the temperature of the isocyanate reaches 75° C., the polyol was added slowly while maintaining the temperature at ≤80° C. The reaction was monitored by measuring the NCO % concentration per ASTM D5155. When close to the theoretical NCO % was reached, the reaction mixture was cooled. The prepolymer can be stored in a sealed glass container under nitrogen at room temperature.

The formulations of NCO-prepolymer based on PDI with PTMEG 1000 polyether polyol are outlined in Tables 7A. The formulations of NCO-prepolymer based on PDI with BDO-Adipate 1000 polyester polyol are outlined in Table 7B.

### Preparation and Testing of TPUs

TPUs were prepared by reacting PDI NCO-terminated prepolymers with 1,4-BDO chain extender at isocyanate index of 1.02. NCO-prepolymers preheated at 80° C. and dry BDO chain extender with catalyst were weighed into a cup and mixed for 45 seconds at 2200 rpm using a multi-axial mixer (Speed Mixer, Flack Tek Inc.). Afterwards, the mixture was transferred into an aluminum mold covered with Teflon™ sheet preheated at 120° C. At gel time, the mold was closed and TPU cured for 2 hours at 120° C. Afterwards, the samples were post-cured for 16 hours at 100° C. in air-circulation oven.

After post-curing, the samples were aged for seven days at room conditions prior to testing. The tests performed on aged samples were the same as the tests performed in Example 1.1.

### Results and Discussion

### NCO Prepolymers

NCO-prepolymers were prepared at 2/1 isocyanate to polyols equivalent ratio with PDI isocyanate using PTMEG 1000 and BDO-Adipate 1000 polyols. The formulations of prepolymers and basic parameters in synthesis are presented in Tables 7A and 7B. All prepolymers were obtained at isocyanate content close to theoretical. The viscosity of NCO-prepolymers at 70° C. was relatively low, which was convenient in processing (Tables 7A and 7B). PDI/PTMEG1000 prepolymer was liquid at room temperature. PDI/BDO-Adipate 1000 prepolymer was solid at room temperature.

DSC analyses of PDI prepolymers based on BDO-Adipate 1000 polyester polyol indicates crystallinity associated with the polyol soft segment at about 45° C. PDI/PTMEG 1000 prepolymer has crystalline transition at 13° C.

### Thermoplastic Polyurethanes

TPUs based on PDI isocyanate prepolymers were prepared under the same conditions (Table 8). A small amount of tin-catalyst was used in the formulation.

All TPUs were essentially transparent a room temperature, indicating low degree of crystallinity.

FTIR analysis of TPUs showed no significant absorption related to free NCO-groups at 2270 cm-1, indicating completion of polyurethane polymerization.

Analyses of TPUs via DSC showed no crystalline associated with the soft polyol segment. As expected, glass transition temperature of TPUs based on polyether PTMEG 1000 was lower than TPUs based on polyester BDO Adipate 1000.

The following is the summary of key physico-mechanical properties of TPUs, which are presented in Tables 9A and 9B:
All TPUs exhorted low compression set, which is a desirable performance for TPUs.
The resilience of PDI based TPUs is high. High resilience can be a desirable performance requirement in many TPU and elastomer applications.
Tensile strength of polyester TPUs is higher than that of polyether TPUs, which is expected.
The elasticity, as measured by elongation at break, is very high for all TPUs.
The heat resistance of TPUs was measured as retention of tensile properties at 50° C. (Table 9B). Heat retention of polyether TPUs was somewhat lower than that of polyester TPUs. The tensile strength is reduced at 50° C. compared to room temperature, as expected.
All TPUs exhibited excellent retention of properties upon hydrolytic aging (Table 9B). This is especially important for polyester TPUs, which are in general more susceptible to moisture than polyether TPUs.

TABLE 7A
Formulations and properties of NCO-prepolymers based on PTMEG 1000

| | | PDI/PTMEG1000 PP | PDI/PTMEG1000 PP | PDI/PTMEG1000 PP |
|---|---|---|---|---|
| Prepolymer Designation | | (Batch 1) | (Batch 2) | (Batch 3) |
| Batch Size (g) | | 260 | 400 | 640 |
| Components | Eq. Wt | | | |
| PTMEG 1000 | 531.25 | 200.85 | 308.51 | 492.23 |
| Dabco ™ T12 | — | — | — | — |
| PDI | 78.95 | 60.04 | 92.38 | 147.77 |
| Total Mass (g) | | 260.89 | 400.89 | 640.21 |
| Properties | | | | |
| NCO/OH Ratio | | 2.02 | 2.02 | 2.02 |
| Theoretical NCO % | | 6.16 | 6.18 | 6.20 |
| Final NCO % * | | 6.12 | 6.08 | 5.93 |
| Viscosity at 70° C., cps | | 1014 | — | — |

Notes:
* NCO % checked prior to making TPUs samples
Syntheses was carried out at 80° C. under nitrogen blanket. No catalyst was required. PDI prepolymers were liquid at room temperature.

TABLE 7B
Formulation and properties of NCO-prepolymer
synthesis with BDO-Adipate 1000

| | | PDI/Piothane1000 |
|---|---|---|
| Prepolymer Designation | | BA PP |
| Batch Size (g) | | 600 |
| Components | Eq. Wt | |
| Piothane ™ 1000 BA | 496.90 | 449.08 |
| PDI | 78.95 | 147.71 |
| Total Mass (g) | | 596.79 |
| Properties | | |
| NCO/OH Ratio | | 2.02 |
| Theoretical NCO % | | 6.53 |
| Final NCO % * | | 6.60 |
| Viscosity at 70° C., cps | | 2082 |

Notes:
* NCO % checked prior to making TPUs samples
Syntheses was carried out at 80° C. under nitrogen blanket. No catalyst was required for synthesis of BDO-Adipate 1000 based NCO-prepolymer. Prepolymer was solid at room temperature.

TABLE 8
TPU formulations and syntheses-PDI NCO prepolymers
with BDO chain extender

| | | PDI/ | PDI/BDO |
|---|---|---|---|
| Formulation | | PTMEG | Adipate |
| Components | Eq. Wt. | 1000 | 1000 |
| PDI/PTMEG 1000 | 708.26 | 56.54 | — |
| Prepolymer | | | |
| PDI/BDO Adipate 1000 | 636.4 | | 56.23 |
| Prepolymer | | | |
| 1,4 Butanediol (BDO) | 45.06 | 2.75 | 2.90 |
| Dabco ™ T-12 (Actual | — | 0.06 | 0.02 |
| amount) | | | |

| | | |
|---|---|---|
| Isocyanate Index | 1.02 | 1.02 |
| Total Mass, g | 60 | 60 |
| NCO-prep. ° C. | 80 | 80 |
| 1,4 BDO, ° C. | 80 | 80 |
| Speed mix time, s | 45 | 45 |
| Gel time, s | 75-90 | ~240 |
| Sample Appearance | Transparent | Transparent |

TABLE 9A
TPU Properties based on aliphatic diisocyanates

| | PDI/ | PDI/ |
|---|---|---|
| | PTMEG | Piothane ™ |
| Formulation | 1000 | 1000 BA |
| Isocyanate Index | 1.02 | 1.02 |
| Properties | | |
| Hardness, Shore A | 78.6 ± 3.6 | 90.0 ± 1.0 |
| Hardness, Shore D | 25.7 ± 1.8 | 34.0 ± 1.1 |
| Resilience, Bashore rebound, % | 54.9 ± 3.2 | 50.2 ± 3.9 |
| Tensile stress-strain | | |
| Stress at break, psi | 2630 ± 155 | 3624 ± 294 |
| Stress at 100% elongation, psi | 584 ± 22 | 947 ± 19 |
| Stress at 300% elongation, psi | 850 ± 25 | 1317 ± 15 |
| Elongation at break, % | 893 ± 30 | 939 ± 39 |
| Toughness (area under stress-strain), J | 28.73 ± 3.31 | 34.91 ± 3.13 |
| Tear Strength, Die C, N/cm | 750 ± 81 | 1206 ± 93 |
| Compressive Strength, 5% strain, psi | 72.7 ± 11.5 | 98.0 ± 14.7 |
| Compressive Strength, 10% strain, psi | 174.6 ± 14.3 | 302.5 ± 28.7 |
| Compressive Strength, 20% strain, psi | 467.5 ± 22.4 | 762.1 ± 29.8 |
| Compression Set, 22 h | −4.5 ± 0.5 | −5.8 ± 0.1 |
| @ 70° C., % change | | |
| Isopropanol Resistance | 64.1 ± 0.8 | 15.4 ± 0.1 |
| (Mass change), % | | |
| MEK Resistance (Mass change), % | 130.1 ± 3.4 | 64.0 ± 0.7 |
| Oil Resistance (Mass change), % | 1.1 ± 0.1 | 0.3 ± 0.0 |
| Water Resistance (Mass change), % | 2.0 ± 0.1 | 2.1 ± 0.0 |
| DSC, Tg ° C. | −67 | −48.4 |
| DMA, T_{g} by maximum | −57 | −36 |
| tangent Δ, ° C. | | |

TABLE 9B
TPU Properties

| | PDI/PTMEG | PDI/Piothane ™ |
|---|---|---|
| | 1000 | 1000 |
| Formulation | (Batch 2) | BA |
| Isocyanate Index | 1.02 | 1.02 |
| Room Temperature | | |
| Stress at break, psi | 2630 ± 155 | 3624 ± 294 |
| Stress at 100% elongation, psi | 584 ± 22 | 947 ± 19 |
| Stress at 300% elongation, psi | 850 ± 25 | 1317 ± 15 |
| Elongation at break, % | 893 ± 30 | 939 ± 39 |
| Toughness (area under | 28.73 ± 3.31 | 34.91 ± 3.13 |
| stress-strain curve), J | | |
| 50° C. | | |
| Stress at 100% elongation, psi | 320 ± 14 | 522 ± 17 |
| Stress at 300% elongation, psi | 444 ± 24 | 780 ± 49 |
| After 5 days @ 50° C. and 95% RH | | |
| Stress at break, psi | 2231 ± 160 | 3524 ± 254 |
| Stress at 100% elongation, psi | 505 ± 27 | 866 ± 13 |
| Stress at 300% elongation, psi | 800 ± 38 | 1202 ± 19 |
| Elongation at break, % | 891 ± 44 | 1000 ± 63 |

### Example 1.3: Preparation and Properties of PDI-Based TPUs Prepared with PDO Sebacate 2000 as Polyol and Two Different Chain Extenders

### Materials and Methods

TPUs were prepared by bulk polymerization of prepolymer (or quasi-prepolymer) and chain extender, using compression molding method. The NCO-terminated prepolymers were prepared from PDI diisocyanate and relevant polyols at required NCO/OH equivalent ratio.

### Chemicals

The materials used are summarized in Table 10.

TABLE 10
Materials

| Component Name | Description | Supplier |
|---|---|---|
| PDO Sebacate 2000 | PDO-sebacate polyester | Specialty Resins |
| | polyol; 2000-molecular | |
| | weight; Fn = 2 | |
| 1,4 BDO | 1,4 Butanediol | Sigma-Aldrich |
| 1,3 PDO | Propane diol, Susterra | DuPont |
| Dabco ™ T-12 | Dibutyltin dilaurate gel catalyst | Evonik |
| PDI | Bio-based 1,5-pentamethylene | Mojia Biotech |
| | diisocyanate; | |
| | NCO % = 53.2% , | |
| | 78.95 equivalent weight. | |

### NCO Prepolymers

One prepolymer and two quasi-prepolymers were prepared based on PDO Sebacate 2000 (Table 11). Isocyanate content (NCO %) of prepolymers and quasi-prepolymers was measured. The synthesis of prepolymers was carried out in a 1-L glass reactor equipped with an overhead stirrer, nitrogen sweep, and temperature-controlled heating mantle, according to the following procedure: calculated amount of isocyanate was placed in a 1-L glass reaction kettle equipped with a stirring shaft and continuous flow of nitrogen. The reactor was heated with temperature-controlled heating mantle. When the temperature of the isocyanate reached 70° C., polyol was added into the reactor maintaining continuous stirring while maintaining the temperature below 90° C. The reaction was monitored via NCO % titration. After the theoretical NCO % was reached, the reaction was stopped by cooling to room temperature. The prepolymer was stored in a sealed glass bottle under nitrogen at room temperature.

TABLE 11
PDI prepolymer and quasi-prepolymers based on PDO Sebacate 2000

| | | PDI/PDO- | PDI/PDO- | PDI/PDO- |
|---|---|---|---|---|
| Designation | | SBA_2/1 | SBA_3/1 | SBA_4/1 |
| Components | Eq. Wt | | | |
| PDO-SBA 2000 | 1008.99 | 620 | 504.5 | 385 |
| PDI | 77.58 | 101.2 | 118.31 | 120.78 |

| | | | |
|---|---|---|---|
| Total weight (g) | 721.2 | 505.78 | 622.81 |
| Properties | | | |
| NCO/OH | 2.05 | 3.05 | 4.08 |
| Theoretical NCO % | 3.76 | 6.91 | 9.76 |
| End of Reaction NCO % | 3.58 | 6.45 | 9.34 |

### Thermoplastic Polyurethanes

NCO-prepolymers as prepared in Table 11 were preheated at 80° C. and dry chain extender with catalyst were weighed into a cup and mixed for 45 seconds at 2200 rpm using a multi-axial mixer (Speed Mixer, Flack Tek Inc.). Afterwards, the mixture was transferred into an aluminum mold covered with Teflon™ sheet preheated at 120° C. At gel time, the mold was closed and TPU cured for 2 hours at 120° C. Afterwards, the samples were post-cured for 16 hours at 100° C. in an air-circulation oven. After post-curing, the samples were aged for seven days at room conditions prior to testing. TPUs were analyzed via FTIR to confirm absence of unreacted isocyanate associate with a signal at 2270 cm-1. For each type of TPU, test sheets and button samples were prepared as required for various testing per ASTM methods. A summary of the conditions and quantities of the products used to prepare the TPUs is shown in Table 12A. The properties of the TPUs are reported in Table 12B.

TABLE 12A
Preparation of TPUs based on PDI isocyanate and PDO
Sebacate 2000 polyol

| | (PDI/PDO- | (PDI/PDO- | (PDI/PDO- | (PDI/PDO- |
|---|---|---|---|---|
| | SBA_2/1)- | SBA_2/1)- | SBA_3/1)- | SBA_4/1)- |
| TPU Designation | 1,4 BDO | 1,3 PDO | 1,4 BDO | 1,4 BDO |
| Hard Segment, % | 17.4 | 16.9 | 24.2 | 30.8 |
| Formulation (pbw) | | | | |
| PDI/SBA_2/1 | 62.13 | 62.21 | | |
| PDI/SBA_3/1 | — | — | 60.8 | |
| PDI/SBA_4/1 | | | | 57 |
| 1,4 BDO | 1.02 | — | 3.36 | 4.04 |
| 3% Dabco ™ T-12 | 1.67 | — | 0.84 | 1.67 |
| in 1,4 BDO | | | | |
| Dabco ™ T-12 | 0.05 | — | 0.05 | |
| (Actual amount) | | | | |
| 1,3 PDO | — | 0.61 | | — |
| 3% Dabco ™ T-12 | — | 1.67 | | — |
| in 1,3 PDO | | | | |
| Isocyanate index | 1.02 | 1.02 | 1.02 | 1.02 |
| Hard Segment, % | 17.4 | 16.9 | 24.2 | 30.8 |
| Chain extender | 80 | 80 | 80 | 80 |
| temp., ° C. | | | | |
| Prepolymer temp | 80 | 80 | 80 | 80 |
| (pre-mix), ° C. | | | | |
| Mixing time, s | 20 | 20 | 20 | 20 |
| Gel time | 2 min. | 49-53 s | 61-78 s | |

TABLE 12B
Properties of TPUs based on PDI isocyanate and PDO Sebacate 2000 polyol

| | (PDI/PDO- | (PDI/PDO- | (PDI/PDO- | (PDI/PDO- |
|---|---|---|---|---|
| | SBA_2/1)- | SBA_2/1)- | SBA_3/1)- | SBA_4/1)- |
| TPU Designation | 1,4 BDO | 1,3 PDO | 1,4 BDO | 1,4 BDO |
| Hard Segment, % | 17.4 | 16.9 | 24.2 | 30.8 |
| Properties | | | | |
| Hardness, | | | | |
| Shore A: | 79.5 ± 3.1 | 91.4 ± 5.6 | 76.8 ± 4.0 | 86.8 ± 4.3 |
| Shore D: | 33.5 ± 1.7 | 43.4 ± 1.1 | 29.8 ± 3.3 | 27.3 ± 2.6 |
| Resilience, % | 14.3 ± 1.7 | 34.5 ± 3.4 | 29.0 ± 1.4 | 33.8 ± 2.4 |
| Tear strength, N/cm | 1011.6 ± 162.2 | 1020 ± 19 | 1290.8 ± 266.0 | 1192.3 ± 67.2 |
| Room temperature tensile properties | | | | |
| Tensile strength at break, psi | 1521.0 ± 75.7 | 2261.3 ± 561.7 | 2466.8 ± 210.5 | 2666.3 ± 370.4 |
| Elongation at break, % | 434.5 ± 35.2 | 541.4 ± 122.4 | 714.7 ± 66.7 | 610.2 ± 47.4 |
| Yield, % | 22.8 ± 4.16 | 23.2 ± 3.91 | 26.5 ± 1.68 | I |
| Tensile stress at 50% elongation, psi | 1291.9 ± 74.2 | 973.5 ± 132.7 | 1201.0 ± 66.2 | 1230.5 ± 223.3 |
| Tensile stress at 100% elongation, psi | 1315.5 ± 70.43 | 1021.3 ± 135.32 | 1239.4 ± 61.73 | 1332.2 ± 215.68 |
| Tensile stress at 200% elongation, psi | 1342.5 ± 59.34 | 1167.5 ± 160.90 | 1358.7 ± 52.08 | 1584.7 ± 217.20 |
| Tensile stress at 300% elongation, psi | 1368.1 ± 62.5 | 1456.1 ± 196.1 | 1582.3 ± 36.8 | 1770.7 ± 218.8 |
| Modulus (Young's), MPa | 100.0 ± 11.0 | 58.6 ± 10.7 | 81.1 ± 18.1 | 72.1 ± 11.9 |
| Area under the curve, J | 10.08 ± 1.07 | 9.88 ± 3.08 | 21.62 ± 2.49 | 22.34 ± 4.98 |
| Tensile set, % | 86.3 ± 6.7 | 73.8 ± 9.7 | 59.3 ± 3.67 | 57.4 ± 2.97 |
| Tensile properties, 50° C. | | | | |
| Tensile stress at 50% elongation, psi | 662.9 ± 99.6 | 755.8 | 1006.2 ± 32.1 | 832.9 ± 173.2 |
| Tensile stress at 100% elongation, psi | 705.6 ± 79.77 | — | 1011.8 ± 38.05 | 909.7 ± 153.13 |
| Tensile stress at 200% elongation, psi | 734.8 ± 82.32 | — | 1052.6 ± 38.24 | 1082.7 ± 141.42 |
| Tensile stress at 300% elongation., psi, (ret., %) | 762.9 ± 80.8 (56) | (0) | 1198.4 ± 49.8 (76) | 1267.1 ± 124.3 (72) |
| Modulus (Young's), MPa | 48.4 ± 9.6 | 87.3 ± 13.5 | 69.8 ± 21.4 | 66.0 ± 69.0 |
| Tensile properties upon hydrolytic aging | | | | |
| (50° C., 95% RH) | | | | |
| Tensile strength at break, psi | 1653.0 ± 106.5 | 3287 ± 135 | 1677.6 ± 248.3 | 2832.5 ± 248.4 |
| Elongation at break, % | 284.4 ± 147.9 | 896 ± 35 | 473.7 ± 159.9 | 597.5 ± 63.6 |
| Yield | 24.2 ± 1.76 | — | 35.7 | — |
| Tensile stress at 50% elong., psi | 1535.0 ± 81.2 | — | 927.7 ± 60.6 | 1090.3 ± 50.0 |
| Tensile stress at 100% elong.psi | 1578.1 ± 79.08 | 1041 ± 43 | 981.5 ± 57.19 | 1254.0 ± 45.17 |
| Tensile stress at 200% elong, psi | 1609.1 ± 72.86 | — | 1215.0 ± 51.67 | 1627.8 ± 56.17 |
| Tensile stress at 300% elong, psi (ret., %) | 1631.0 ± 36.4 (220) | 1524 ± 39 (105) | 1429.5 ± 48.1 (90) | 1909.6 ± 70 (108%) |
| Modulus (Young's), MPa | 127.7 ± 17.2 | — | 44.5 ± 7.0 | 42.8 ± 9.6 |
| Area under the curve, J | 7.43 ± 4.01 | 34.44 ± 2.49 | 10.82 ± 4.84 | 17.26 ± 1.84 |
| Tensile set, % | 56.8 ± 4.9 | — | 63.7 ± 7.7 | 89.3 ± 3.5 |
| Compressive Strength | | | | |
| Compressive stress at 5% strain | 278.05 ± 171.15 | 127 ± 42 | 191.99 ± 9.91 | 221.93 ± 103.06 |
| Compressive stress at 10% strain | 877.25 ± 620.79 | 531 ± 70 | 680.68 ± 160.62 | 704.94 ± 293.67 |
| Compressive stress at 15% strain | 775.03 | 945 ± 28 | 1611.95 ± 256.99 | 1320.84 ± 378.86 |
| Compressive stress at 20% strain | 1456.41 | — | 2363.13 ± 150.53 | 1903.73 ± 416.49 |
| Compressive stress at 25% strain | — | — | — | 1937.79 |
| Modulus (Young's), MPa | 134.61 ± 31.97 | — | 141.02 ± 9.68 | 87.95 ± 11.90 |
| Compression set (70° C.), Ct | 35.1 ± 3.0 | 3.9 ± 0.7 | 41.3 ± 2.4 | 7.4 ± 2.0 |
| | | | (50° C.) | (50° C.) |
| Solvent Resistance, (Mass gain, %) | | | | |
| Water | 0.88 ± 0.03 | 1.0 ± 0.0 | 0.67 ± 0.07 | 1.00 ± 0.26 |
| IPA | 5.88 ± 0.12 | 12 ± 0 | 6.33 ± 0.43 | 6.52 ± 0.76 |
| Mineral Oil | 1.08 ± 0.26 | 0.5 ± 0.2 | 0.71 ± 0.23 | 1.77 ± 0.40 |
| MEK | 14.8 ± 2.8 | 323 ± 7 | 0.05 ± 0.01 | 18.17 ± 1.56 |

The data reported in the two first columns of Tables 12A and B (PDI/BDO/SBA_2/1/1 and PDI/PDO/SBA_2/1/1) show the impact of using BDO versus PDO as the chain extender on TPU properties. It can be observed that PDO yields PDI-TPUs with higher hardness and tensile strength, despite lower hard segment concentration compared to BDO based PDI-TPU. Also, PDO yields a PDI-TPU with higher resilience, tensile strength, elongation, and lower compression set. The behaviour observed when using a chain extender containing odd number of methylene groups (i.e., 1,3-PDO) may be due to a more favorable conformation for hydrogen bonding of urethane groups resulting in higher levels of urethanes bonded in the hard segment.

Tables 12A and B also show that when higher levels of BDO chain extender are used, this can result in higher hard segment concentrations in the TPUs (see data in columns 1, 3, and 4).

### Example 2: PDI-Based Polyurethane Elastomers

Polyurethane cast elastomers were prepared from biobased PDI and polyether polyol or polyester polyol. Furthermore, the performance of biobased PDI isocyanate was compared to commercial IPDI aliphatic isocyanate in polyurethane cast elastomers based on polyether polyol and polyester polyol.

### Materials and Methods

Cast elastomers were prepared from PDI and IPDI aliphatic isocyanate NCO-prepolymers that were cured with Ethacure™ 300 hindered diamine.

Cast elastomers were prepared using the following aliphatic NCO-prepolymers:
PDI with the blend of PTMG 1000/PTMG 650 (50/50). PDI with PDO Sebacate 2000
IPDI with the blend of PTMG 1000/PTMG 650 (50/50) (Comparative)
IPDI with PDO Sebacate 2000 (Comparative).

NCO-prepolymers were then reacted with Ethacure™ 300 for preparing cast elastomers:
PDI/PTMG 1000/PTMG 650 (50/50)/Ethacure™ 300
PDI/PDO Sebacate 2000/Ethacure™ 300
IPDI/PTMG 1000/PTMG 650 (50/50)/Ethacure™ 300 (Comparative)
IPDI/PDO Sebacate 2000/Ethacure™ 300 (Comparative).

Table 13 below summarizes the information on the reactants used in the experimental.

TABLE 13
Materials

| | | |
|---|---|---|
| Designation | Identification | Supplier |
| Poly(tetrahydrofuran) | PTMG polyol, 1000 MW | Aldrich |
| Terathane ™ T-650 | PTMG polyol, 650 MW | Invista |
| Piothane ™ 2000 PDO- | PDO Sebacate polyol, 2000 MW | Specialty |
| SBA | | Resins |
| PDI | Pentamethylene diisocyanate | Mojia Biotech |
| IPDI | Isophorone diisocyanate | Evonik |
| Ethacure ™ 300 | Curative | Albemarle |
| Cilbond ™ 49SF | Adhesion promoter | H.B. Fuller |
| 2-Butanone | 97% purity; Solvent for | Alfa Aesar |
| | adhesion promoter dilution. | |
| | Also known as MEK | |

### Preparation of NCO-Prepolymers

The NCO-terminated prepolymers, based on aliphatic isocyanate and polyol were prepared at NCO/OH equivalent ratio of 2/1, according to the following procedure: calculated amount of isocyanate was placed in a 1-L glass reaction kettle equipped with a stirring shaft and continuous flow of nitrogen. The reactor was heated with temperature-controlled heating mantle. When the temperature of the isocyanate reaches 70° C., polyol was added into the reactor maintaining continuous stirring while maintaining the temperature below 90° C. The reaction was monitored via NCO % titration. After the theoretical NCO % was reached, the reaction was stopped by cooling to room temperature. The prepolymer was stored in a sealed glass bottle under nitrogen at room temperature.

The following properties of TDI NCO-prepolymers were measured:
NCO % via TPI-internal procedure based on TSI
Viscosity at 70° C. via Brookfield viscometer per ASTM D-4878
Thermal Properties via DSC.

### Preparation of Cast Elastomers

Cast elastomers were prepared by reaction NCO-prepolymers with Ethacure™ 300 at 1.05 to 1 equivalent ratio. Calculated amount of prepolymer was weighed into a 100 g cup (suited for Speed Mixer) and heated in an oven at 80° C. for one hour. Calculated amount of Ethacure™ 300 was added to the prepolymer and mixed by a planetary mixer (Speed Mixer, FlackTek™ Inc.) for one minute. At gel time, the mixture was transferred into an aluminum mold covered with a Teflon™ sheet pre-heated to 80° C. The mold was placed in the hydraulic press and the resin compression-molded at about 20,000 psi for 60 minutes.

Cast elastomers sheets (6×6 inches and 3 mm thickness) and cylindrical sample “buttons” (D=1 in, H=½ in) were prepared for testing. Samples were aged at room temperature for seven days prior to testing.

### Testing of Cast Elastomers

The following properties of cast elastomers were measured:
Hardness, Shore A, ASTM D-2240
Tensile stress-strain properties at RT, ASTM-412 (Tensile strength at break, 100% and 300% modulus, elongation at break)
Tear resistance, Graves die C, ASTM D-624.
Resilience, Bashore rebound, ASTM D 430
Heat Resistance (Tensile properties at 50 and 70° C.)
Hydrolytic stability (weight change and change of stress-strain properties with exposure to 100% RH at 60° C. for 5 days). The retention of tensile properties is calculated.
Abrasion resistance, ASTM D 1044
Oil resistance in selected hydraulic oil (weight change after three days of immersion at room temperature)
Resistance in water solution (higher than pH 7 and lower than pH 7), (weight change after three days of immersion at room temperature).
Glass Transition Temperatures (T_{g}) via DSC.

### Adhesion Testing of Cast Elastomers

The adhesion test specimens were prepared using steel panels RS-14 (Q-Lab Corporation) of (dimensions 3-inch×1 inch) substrate. Steel panels were pre-treated with the adhesion promotors which is utilized to enhance the adhesion of cast elastomers to steel, as is convention in production of protective urethane liners for pipe protection.

NCO-prepolymer and curative Ethacure™ 300 were mixed at specified weight ratio, depending on the formulation via planetary mixer. Mixed resin was placed in an oven at 60° C. to thicken. ˜0.15 g of the resin was spread onto end (0.5 inches) of each steel plate. Two plates were clamped overlapping each other by 0.5 inches. The samples were cured in an oven for 1 hour at 60° C. The samples were aged for three days at room temperature prior to testing.

The adhesion properties were tested via ASTM D1002 Adhesive Lap Joint Test.

The adhesion samples were also humid aged (95% RH at 60° C. for 5 days) and tested after aging.

### Results and Discussion

The results are summarized in Tables 14 to 20 below.

TABLE 14
Properties of materials for prepolymers

| | Moisture, | Moisture after | OH Value, | NCO |
|---|---|---|---|---|
| Material | % | drying, % | mg KOH/g | % |
| PTMG 1000 | 0.027 | — | 112.2 | — |
| PTMG 650 | 0.612 | 0.054 | 165.5 | — |
| PDO Sebacate 2000 | 0.044 | — | 55.6 | — |
| IPDI | — | — | — | 37.8 |
| PDI | — | — | — | 53.2 |

TABLE 15
Synthesis and properties of NCO-prepolymers

| | PP- | PP- | PP- | PP- |
|---|---|---|---|---|
| | PTMG- | PTMG- | SbPDO- | SbPDO- |
| | IPDI* | PDI* | IPDI* | PDI* |
| PTMG 1000 | 193.55 | 215.70 | — | — |
| PTMG 650 | 193.55 | 215.70 | — | — |
| PDO Sebacate 2000 | — | — | 491.71 | 518.55 |
| IPDI | 212.91 | — | 108.29 | — |
| PDI | — | 168.59 | — | 81.45 |
| Ratio of NCO/OH | 2/1 | | | |
| Reaction temperature, | 76 (82) | 78 (88) | 75 (77) | 82 (89) |
| ° C.* | | | | |
| Theoretical NCO % | 6.71 | 7.47 | 3.41 | 3.60 |
| Reaction duration, min | 152 | 258 | 180 | 145 |
| Final NCO % | 6.50 | 7.51 | 3.38 | 3.55 |
| Viscosity at | 5,830 | 560 | 23,350 | 9,180 |
| 70° C., mPa · s | | | | |
| Glass transition | −49.2 | −79.1 | −51.4 | −57.6 |
| (T_{g}), ° C. | | | | |
| Melting temperature | — | 12.1 | 50.8 | 52.9 |
| (Tₘ), ° C. | | | | |
| State at RT | Viscous | Liquid | Solid | Solid |
| | liquid | | | |

*PP = prepolymer
**Average temperature during synthesis (maximum temperature reached in parenthesis)

TABLE 16
Preparation of cast elastomers (CE = cast elastomer)

| | CE- | CE- | CE- | CE- |
|---|---|---|---|---|
| | PTMG- | PTMG- | SbPDO- | SbPDO- |
| | IPDI | PDI | IPDI | PDI |
| PP-PTMG-IPDI | 51.83 | — | — | — |
| PP-PTMG-PDI | — | 50.75 | — | — |
| PP-SbPDO-IPDI | — | — | 55.45 | — |
| PP-SbPDO-PDI | — | — | — | 55.24 |
| Ethacure ™ 300 | 8.17 | 9.25 | 4.55 | 4.76 |
| Reactivity | | | | |
| Gel time, min | 12.8 | 5.4 | 18 | 10.8 |
| Consistency after | Soft/ | Solid/ | Soft/ | Solid/ |
| press removal | Taffy-like | flexible | taffy-like | flexible |
| Consistency after | Flexible, | Flexible, | Solid/ | Solid/ |
| 24 hours at RT | transparent | transparent | mildly | mildly |
| | | | flexible, | flexible, |
| | | | translucent | translucent |

Reaction conditions

| Isocyanate index | 1.05 | |
|---|---|---|
| Prepolymer preheat | 80° | C. |
| temperature | | |
| Mix time | 90 | s |
| Press preheat | 80° | C. |
| temperature | | |
| Press compression | 20,000 | psi |
| Duration in press | 60 | min |
| Room temperature | 7 | days |
| aging | | |

TABLE 17
DSC analysis of cast elastomers

| | CE- | CE- | CE- | CE- |
|---|---|---|---|---|
| | PTMG- | PTMG- | SbPDO- | SbPDO- |
| | IPDI | PDI | IPDI | PDI |
| Glass transition (T_{g}), ° C. | −49.8 | −64.3 | −44.8 | −47.3 |
| Crystallization temperature, ° C. | — | — | 3.1, 43.2 | 41.2 |

TABLE 18
Properties of cast elastomers

| | CE- | CE- | CE- | CE- |
|---|---|---|---|---|
| | PTMG- | PTMG- | SbPDO- | SbPDO- |
| | IPDI | PDI | IPDI | PDI |
| Hardness, Shore A | 76 ± 3 | 93 ± 2 | 84 ± 3 | 94 ± 3 |
| Resilience, | 25 ± 2 | 48 ± 2 | 30 ± 3 | 42 ± 2 |
| Bashore rebound | | | | |
| Abrasion resistance, | 278 | 10 | 143 | 70 |
| mg loss/1000 | | | | |
| cycles (H-22, | | | | |
| 500 g, 2000 cycles) | | | | |
| Tear strength, N/cm | 704 ± 29 | 1458 ± 95 | 1034 ± 29 | 1292 ± 141 |
| Tensile properties at RT | | | | |
| Tensile strength | No yield | No yield | 2201 ± 180 | 1584 ± 119 |
| at yield, psi | | | | |
| Elongation at yield, % | — | — | 13 ± 1 | 18 ± 1 |
| Tensile strength | 1174 ± 53 | 2393 ± 110 | 1310 ± 161 | 3280 ± 299 |
| at break, psi | | | | |
| Elongation at break, % | 540 ± 28 | 675 ± 39 | 94 ± 10 | 760 ± 38 |
| Tensile strength at | 657 ± 34 | 1428 ± 41 | — | 1443 ± 139 |
| 100% elongation, psi | | | | |
| Tensile strength at | 982 ± 49 | 1812 ± 48 | — | 1842 ± 132 |
| 300% elongation, psi | | | | |
| Tensile Set, % | 27.8 ± 2.6 | 41.8 ± 1.8 | 6.7 ± 1.1 | 51.2 ± 3.4 |
| Area under the curve, J | 8.4 ± 0.8 | 22.0 ± 1.6 | 2.7 ± 0.4 | 27.2 ± 4.4 |
| Modulus | 16.0 ± 1.0 | 58.3 ± 7.1 | 295 ± 14 | 182 ± 11 |
| (Young's), MPa | | | | |
| Tensile properties | | | | |
| at 50° C. | | | | |
| Tensile strength | No break* | No break* | No break* | No break* |
| at break, psi | | | | |
| Tensile elongation | No break* | No break* | No break* | No break* |
| at break, % | | | | |
| Tensile strength at | 210 ± 6 | 1288 ± 27 | 62 ± 2 | 526 ± 12 |
| 100% elongation, psi | | | | |
| Tensile strength at | 313 ± 10 | 1595 ± 27 | 87 ± 5 | 812 ± 11 |
| 300% elongation, psi | | | | |
| % strength retention at | 32.0 | 90.2 | N/A | 36.5 |
| 100% elongation | | | | |
| Tensile properties | | | | |
| at 70° C. | | | | |
| Tensile strength | No break* | No break* | No break* | No break* |
| at break, psi | | | | |
| Tensile elongation | No break* | No break* | No break* | No break* |
| at break, % | | | | |
| Tensile strength at | 62 ± 4 | 1176 ± 21 | 25 ± 2 | 467 ± 20 |
| 100% elongation, psi | | | | |
| Tensile strength at | 75 ± 6 | 1408 ± 27 | 29 ± 3 | 676 ± 29 |
| 300% elongation, psi | | | | |
| % strength retention | 9.4 | 82.4 | N/A | 32.4 |
| at 100% elongation | | | | |
| Tensile properties after | | | | |
| 5 days 95% | | | | |
| RH at 60° C. | | | | |
| Tensile strength | 1081 ± 98 | 3582 ± 313 | 703 ± 164 | 3793 ± 153 |
| at break, psi | | | | |
| Elongation at break, % | 526 ± 36 | 578 ± 52 | 762 ± 111 | 791 ± 25 |
| Tensile strength at | 479 ± 27 | 1440 ± 17 | 145 ± 7 | 585 ± 19 |
| 100% elongation, psi | | | | |
| Tensile strength at | 780 ± 42 | 2131 ± 16 | 241 ± 19 | 1363 ± 34 |
| 300% elongation, psi | | | | |
| % strength retention | 72.9 | 100.8 | N/A | 40.5 |
| at 100% elongation | | | | |
| Tensile set, % | 19.3 ± 2.4 | 13.6 ± 1.9 | 167 ± 6 | 10.6 ± 2.0 |
| Area under the curve, J | 7.4 ± 0.9 | 19.3 ± 0.8 | 5.1 ± 1.7 | 28.3 |
| Modulus | 9.3 ± 1.0 | 37.8 ± 6.1 | 1.0 ± 0.3 | 4.7 ± 0.2 |
| (Young's), MPa | | | | |

TABLE 19
Resistance of cast elastomers to various solutions, % weight
change after 3 days immersion

| | CE-PTMG- | CE-PTMG- | CE-SbPDO- | CE-SbPDO- |
|---|---|---|---|---|
| | IPDI | PDI | IPDI | PDI |
| Hydraulic Oil | 0.13 | 0.37 | 0.06 | 0.09 |
| 0.1N HCl | 2.00 | 2.54 | 0.80 | 0.91 |
| 0.1N NaOH | 2.14 | 2.59 | 0.81 | 0.90 |

TABLE 20
Adhesive properties of cast elastomers on steel panels treated
with adhesion promoter

| | CE- | CE- | CE- | CE- |
|---|---|---|---|---|
| | PTMG- | PTMG- | SbPDO- | SbPDO- |
| | IPDI | PDI | IPDI | PDI |
| Initial: | | | | |
| Load at failure, psi | 865 ± 91 | 1706 ± 75 | 1372 ± 66 | 1976 ± 116 |
| Strain at failure, % | 8.0 ± 0.5 | 12.9 ± 0.3 | 10.6 ± 0.8 | 14.2 ± 0.7 |
| Area under the | 1.2 ± 0.3 | 3.3 ± 0.8 | 2.2 ± 0.2 | 4.3 ± 0.6 |
| curve, J | | | | |
| Modulus | 899 ± 144 | 964 ± 138 | 1081 ± 112 | 1236 ± 203 |
| (Young's), MPa | | | | |
| Failure type | Cohesive | Cohesive | Cohesive | Cohesive |
| After aging 5 days, | | | | |
| 60° C. and 95% RH: | | | | |
| Load at failure, psi | 947 ± 210 | 1457 ± 133 | 313 ± 107 | 910 ± 72 |
| Strain at failure, % | 9.3 ± 1.2 | 12.2 ± 1.1 | 7.0 ± 1.8 | 8.6 ± 0.7 |
| Area under the | 1.6 ± 0.4 | 3.0 ± 1.0 | 0.4 ± 0.1 | 1.1 ± 0.2 |
| curve, J | | | | |
| Modulus | 919 ± 75 | 902 ± 150 | 600 ± 88 | 890 ± 165 |
| (Young's), MPa | | | | |
| Failure type | Cohesive | Adhesive | Cohesive | Adhesive |
| % retention of strength | 109.5 | 85.4 | 22.8 | 46.1 |

From the results reported above, one can observe that:
The NCO-prepolymers at expected NCO % were prepared using conventional method for preparation of NCO-prepolymers (Table 15). The prepolymers based on PDI isocyanate exhibited significantly lower viscosity than those based on IPDI isocyanate, which can be beneficial in cast elastomer application. In preparation of cast elastomers, NCO-prepolymers based on PDI showed somewhat higher reactivity, reflected by faster gel time (Table 16).
Glass transition temperature of PDI cast elastomers was lower than that of IPDI cast elastomers, which could indicate better phase separation of hard and soft segments (Table 17). Reduced glass transition of cast elastomers could be useful in low-temperature applications.
Cast elastomers based on PDI isocyanate exhibited higher hardness and higher resilience than those based on IPDI, which is an interesting combination of properties (Table 18). PDI based cast elastomers have lower hard segment concentration than those based on IPDI, which would typically result in lower hardness. However, improved hardness is most likely due to more ordered morphology and better hard segment phase separation in cast elastomers based on PDI compared to IPDI.
Cast elastomers based on PDI exhibited higher tensile strength at break, tensile modulus at 100%, and elongation at break compared to corresponding cast elastomers based on IPDI (Table 17). As a result, cast elastomers based on PDI exhibited higher toughness (measured as area under tensile curve). Toughness of elastomers is very important in applications where materials are exposed to dynamic stresses.
Tear strength of cast elastomers based on PDI was higher than those of corresponding cast elastomers based on IPDI, which could be correlated with improved toughness (Table 17).
The abrasion resistance of PDI based cast elastomers was much better compared to corresponding cast elastomers based on IPDI (Table 17). The abrasion resistance of polyester PDI elastomers, as measured by weight loss in Taber abrader test, was about two times better than that of corresponding polyester IPDI elastomers. In case of PTMG based cast elastomers, PDI yielded cast elastomers with Taber weight loss that was dramatically lower compared to IPDI based cast elastomers. The abrasion resistance is a crucial property of cast elastomers in many applications that require low wear.
Heat and humid resistance of PDI/PTMG cast elastomers was much better compared to IPDI/PTMG cast elastomers (Table 17). The retention of tensile modulus with temperature was much better for PDI based elastomer elastomers. The retention of tensile modulus after humid temperature age was much better for PDI based cast elastomers.
The solvent resistance was measured by determination of weight gain after immersion in hydraulic oil and acidic and basis water media (Table 17). The weight gain in PDI based cast elastomer was slightly higher compared to the cast elastomers based on IPDI.
PDI cast elastomers exhibited much better adhesion to metal than IPDI cast elastomers (Table 20). PDI cast elastomers also exhibited stronger adhesion to metal after humid age.

1- A biobased thermoplastic polyurethane (TPU) obtained from a biobased monomeric pentamethylene diisocyanate (PDI), at least one polyol being optionally biobased selected from a polyester diol, a polyether diol, and a combination thereof, in the presence of at least one hydroxyl functionalized chain extender, wherein the PDI has a biobased content of at least 70%.

2- The biobased TPU according to claim 1, wherein the polyester diol is optionally biobased and comprises a succinate based polyester diol, an adipate based polyester diol, a sebacate based polyester diol, an azelate based polyester diol, a 1,18-octadecanedioic diacid based polyester diol, or any combination thereof.

3- The biobased TPU according to claim 1 or 2, wherein the polyester diol is optionally biobased and is synthesized from an organic diacid selected from succinic acid, adipic acid, sebacic acid, azelaic acid, a 1,18-octadecanedioic diacid, and any combination thereof, with a diol being selected from 1,4-Butanediol (1,4-BDO), 1,3-Propanediol (1,3-PDO), and a mixture thereof.

4- The biobased TPU according to any one of claims 1 to 3, wherein the polyester diol is optionally biobased and is selected from 1,4-BDO-adipate, 1,3-PDO-adipate, 1,4-BDO-Sebacate, 1,3-PDO-sebacate, and any combination thereof, preferably 1,3-PDO-sebacate.

5- The biobased TPU according to any one of claims 1 to 4, wherein the polyether diol is optionally biobased and is selected from a polytrimethylene ether glycol (PO3G), a polytetramethylene ether glycol (PTMEG or PTMG), a polyethylene glycol, and any combination thereof, preferably polytrimethylene ether glycol (PO3G).

6- The biobased TPU according to any one of claims 1 to 5, wherein the polyol has a molecular weight of at least 500 g/mol, for instance ranging from 500 to about 10000 g/mol, preferably ranging from 500 to about 3000 g/mol.

7- The biobased TPU according to any one of claims 1 to 6, wherein the chain extender is selected from 1,3-PDO, butane diols, pentane diols, hexanediols, ethylene glycol, propylene glycol, Hydroquinone bis(2-hydroxyethyl) ether (HQEE), 1,3-bis(2-hydroxyethyl) resorcinol (HER), cyclohexane dimethanol (CHDM), 3-methyl-1,5-pentanediol, 2-butyl-2-ethyl-1,3-propanediol, and any combination thereof, preferably biobased 1,3-PDO and biobased 1,4-BDO.

8- The biobased TPU according to any one of claims 1 to 7, wherein the chain extender has an odd number of carbon atoms.

9- The biobased TPU according to any one of claims 1 to 8, wherein the molar ratio of PDI to polyol to chain extender is from about 1.5:1:0.5 to about 4:1:3, preferably from about 1.5:1:0.5 to about 3:1:2, more preferably from 2:1:1 to 3:1:1.

10- The biobased TPU according to any one of claims 1 to 8, wherein the TPU is obtained by reacting an NCO-terminated prepolymer produced from the biobased monomeric PDI and the at least one polyol, with the at least one chain extender.

11- The biobased TPU according claim 10, wherein the NCO-terminated prepolymer is produced by reacting the PDI and the polyol at 1.1:1 to 10:1 molar ratio under heating at a temperature ranging from about 50° C. to about 120° C.

12- The biobased TPU according claim 10 or 11, wherein the NCO-terminated prepolymer is produced by reacting the PDI and the polyol at a molar ratio of at least 2:1.

13- The biobased TPU according to any one of claims 10 to 12, wherein the NCO-terminated prepolymer has a biobased content of at least 90%.

14- The biobased TPU according to any one of claims 10 to 13, wherein the NCO-terminated prepolymer has a viscosity at 70° C. ranging from about 100 cps to about 10000 cps, preferably from about 500 cps to about 7000 cps.

15- The biobased TPU according to any one of claims 1 to 14, wherein the TPU has a content of hard segment ranging from about 10 wt % to about 40 wt %.

16- The biobased TPU according to any one of claims 1 to 15, wherein the biobased TPU has a biobased content of at least 90%.

17- The biobased TPU according to claim 1, obtained from pentamethylene diisocyanate (PDI) having a biobased content of at least 70% and biobased 1,3-PDO-sebacate polyester diol having a molecular weight of about 1000 g/mol, the chain extender is biobased 1,3-PDO, the molar ratio of PDI to biobased polyol to chain extender is about 2:1:1, and wherein the TPU has a content of hard segment from about 20 wt % to about 30 wt %, preferably from about 25 wt % to about 30 wt %.

18- The biobased TPU according to claim 1, obtained from pentamethylene diisocyanate (PDI) having a biobased content of at least 70% and biobased 1,3-PDO-sebacate polyester diol having a molecular weight of about 2000 g/mol, the chain extender is biobased 1,3-PDO, the molar ratio of PDI to biobased polyol to chain extender is about 2:1:1, and wherein the TPU has a content of hard segment from about 10 wt % to about 20 wt %, preferably from about 13 wt % to about 18 wt %.

19- The biobased TPU according to any one of claims 1 to 18, wherein the TPU is characterized by a tensile stress at break at room temperature of at least 3000 psi.

20- The biobased TPU according to claim 1, obtained from pentamethylene diisocyanate (PDI) having a biobased content of at least 70% and biobased 1,3-PDO-sebacate polyester diol, the chain extender is biobased 1,3-PDO, and wherein the TPU is characterized by a tensile stress at break at room temperature of at least 3000 psi.

21- A PDI-based elastomer obtained from a biobased monomeric pentamethylene diisocyanate (PDI) and at least one polyol selected from a polyester polyol, a polyether polyol, and a combination thereof, in the presence of at least one curative agent, wherein the PDI has a biobased content of at least 70%.

22- The PDI-based elastomer according to claim 21, wherein the PDI-based elastomer has a biobased content of from about 20% to about 100%.

23- The PDI-based elastomer according to claim 21 or 22, wherein the polyester polyol is a succinate based polyester diol, an adipate based polyester diol, a sebacate based polyester diol, an azelate based polyester diol, a 1,18-octadecanedioic diacid based polyester diol, or any combination thereof.

24- The PDI-based elastomer according to any one of claims 21 to 23, wherein the polyester polyol is optionally biobased and is synthesized from an organic diacid selected from succinic acid, adipic acid, sebacic acid, azelaic acid, a 1,18-octadecanedioic diacid, and any combination thereof, with a diol being selected from 1,4-Butanediol (1,4-BDO), 1,3-Propanediol (1,3-PDO), and a mixture thereof.

25- The PDI-based elastomer according to any one of claims 21 to 24, wherein the polyester polyol is optionally biobased and is selected from 1,4-BDO-adipate, 1,3-PDO-adipate, 1,4-BDO-Sebacate, 1,3-PDO-sebacate, and any combination thereof, preferably 1,3-PDO-sebacate.

26- The PDI-based elastomer according to any one of claims 21 to 25, wherein the polyether polyol is optionally biobased and is selected from polytrimethylene ether glycols (PO3G), polytetramethylene ether glycols (PTMEG or PTMG), polyethylene glycols, and any combination thereof, preferably the polyether diol comprises at least one polytetramethylene ether glycol (PTMEG or PTMG).

27- The PDI-based elastomer according to any one of claims 21 to 26, wherein the polyol has a molecular weight of at least 500 g/mol, preferably ranging from 500 to about 10000 g/mol, more preferably ranging from 500 to about 3000 g/mol.

28- The PDI-based elastomer according to any one of claims 21 to 27, wherein the curative agent is selected from a sterically hindered diamine, a diol, a polyol, a secondary diamine, a diamine ether oligomer, and any combination thereof.

29- The PDI-based elastomer according to any one of claims 21 to 28, wherein the curative agent comprises a sterically hindered diamine comprising an aromatic diamine with two primary amino groups, or with one primary amino group and one secondary amino group, or with two secondary amino groups.

30- The PDI-based elastomer according to any one of claims 21 to 29, wherein the elastomer is obtained by reacting an NCO-terminated prepolymer produced from the biobased monomeric PDI and the at least one polyol, with the at least one curative agent.

31- The PDI-based elastomer according to claim 30, wherein the curative agent is reacted with the NCO-terminated prepolymer in a molar ratio NCO-terminated prepolymer to curative agent of about 0.95:1 to about 1.10:1, preferably about 1.05:1.

32- The PDI-based elastomer according to any one of claims 21 to 31, wherein the molar ratio of PDI to polyol is at least 1.1:1, preferably from 1.1:1 to 10:1, more preferably from 1.5:1 to 4:1, and even more preferably from 2:1 to 3:1.

33- The PDI-based elastomer according to any one of claims 21 to 32, wherein the PDI-based elastomer presents a hardness higher than a hardness of an Isophorone diisocyanate-based elastomer (IPDI-based elastomer) and the PDI-based elastomer presents a resilience that is higher than a resilience of the IPDI-based elastomer where the IPDI-based elastomer is prepared using the same polyol, same curative agent and in the same molar ratio and conditions as the PDI-based elastomer, preferably the resilience of the PDI-based elastomer is at least 1.2 times higher than the resilience of the IPDI-based elastomer.

34- The PDI-based elastomer according to any one of claims 21 to 33, wherein the PDI-based elastomer presents a tensile strength at break at room temperature higher than a tensile strength at break at room temperature of an IPDI-based elastomer and the PDI-based elastomer presents an elongation at break at room temperature that is higher than an elongation at break at room temperature of the IPDI-based elastomer, where the IPDI-based elastomer is prepared using the same polyol, same curative agent and in the same molar ratio and conditions as the PDI-based elastomer, preferably the tensile strength at break at room temperature of the PDI-based elastomer is at least 1.8 times higher than the tensile strength at break at room temperature of the IPDI-based elastomer.

35- The PDI-based elastomer according to any one of claims 21 to 34, wherein the PDI-based elastomer presents an abrasion resistance higher than an abrasion resistance of an IPDI-based elastomer, where the IPDI-based elastomer is prepared using the same polyol, same curative agent and in the same molar ratio and conditions as the PDI-based elastomer.

36- The PDI-based elastomer according to any one of claims 21 to 35, wherein the PDI-based elastomer presents a tear strength higher than a tear strength of an IPDI-based elastomer, where the IPDI-based elastomer is prepared using the same polyol, same curative agent and in the same molar ratio and conditions as the PDI-based elastomer.

37- The biobased TPU according to any one of claims 1 to 20, or the PDI-based elastomer according to any one of claims 21 to 36, wherein the PDI is obtained by a process comprising:
subjecting a solution comprising a cadaverine salt dissolved in an inert solvent in the presence of a tertiary amine base, to a liquid-phase phosgenation reaction using a phosgene source, to convert the cadaverine to PDI,
wherein the phosgenation reaction comprises a step of maintaining the reaction at a temperature range between 100° C. and 120° C. for a sufficient time to achieve a desired threshold yield of PDI,
wherein the tertiary amine base is present in an amount to enable the phosgenation reaction to occur to completion at said temperature range.

38- The biobased TPU or the PDI-based elastomer according to claim 37, wherein said sufficient time is at least 1.5 hours.

39- The biobased TPU or the PDI-based elastomer according to claim 37 or 38, wherein the phosgenation reaction is a multistage phosgenation reaction comprising at least a first stage in which the solution is heated to a first temperature such that the cadaverine reacts with phosgene from the phosgene source to produce a dicarbamoyl chloride intermediate, and a subsequent second stage in which the solution is further heated to a second temperature higher than the first temperature to subject the dicarbamoyl chloride intermediate to dehydrochlorination, wherein the second stage comprises said step of maintaining the reaction at temperatures between 100° C. and 120° C. for a sufficient time to achieve a threshold yield of PDI.

40- The biobased TPU or the PDI-based elastomer according to claim 39, wherein the first temperature is from about 30 to about 65° C. and the first stage comprises maintaining the solution at the first temperature for at least 0.5 hours.

41- The biobased TPU or the PDI-based elastomer according to any one of claims 37 to 40, wherein the second temperature is higher than the first temperature by at least 10° C.

42- The biobased TPU or the PDI-based elastomer according to any one of claims 37 to 41, wherein the process employs 3 to 30 mols of phosgene per mole of cadaverine salt and at least 4 mols of tertiary amine base per mole of cadaverine salt.

43- The biobased TPU or the PDI-based elastomer according to any one of claims 37 to 42, wherein the cadaverine salt is obtained from fermentation and/or enzymatic conversion, and a content of 2,3,4,5-tetrahydropyridine (THP) or other cyclic by-product impurity in the cadaverine salt is below 0.1 wt %.

44- The biobased TPU or the PDI-based elastomer according to any one of claims 37 to 43, wherein the cadaverine salt is cadaverine dihydrochloride.

45- The biobased TPU or the PDI-based elastomer according to any one of claims 37 to 44, wherein the phosgene source is triphosgene and the tertiary amine base is reacted with the triphosgene to release phosgene for the phosgenation reaction.

46- The biobased TPU or the PDI-based elastomer according to any one of claims 37 to 45, wherein the tertiary amine base is a heterocyclic amine or a tertiary amine base having a sp²-hybridized N atom, preferably pyridine.

47- The biobased TPU or the PDI-based elastomer according to any one of claims 37 to 46, wherein the inert solvent comprises or consists of chlorobenzene, dichlorobenzene, toluene, nitrobenzene, or any mixture thereof and/or the inert solvent is a solvent or solvent mixture having a boiling point of at least 120° C.

48- The biobased TPU or the PDI-based elastomer according to any one of claims 37 to 47, wherein the PDI produced has a content of THP or other cyclic by-product impurity of below 0.1 wt % before being subject to one or more distillation steps.

49- The biobased TPU or the PDI-based elastomer according to any one of claims 37 to 48, wherein the desired threshold yield of PDI is at least 50%.
